(19) United States
(12) Patent Application Publication
(10) Pub. No.: US 2015/0242877 A1
(43) Pub. Date: Aug. 27, 2015

(54) SYSTEM FOR WEARABLE COMPUTER DEVICE AND METHOD OF USING AND PROVIDING THE SAME

(71) Applicant: Atigeo Corporation, Bellevue, WA (US)

(72) Inventors: John Bliss, Boulder, CO (US); Warren Lyndes, Boulder, CO (US); Jacob Timm, Boulder, CO (US); Andy Woolard, Boulder, CO (US)

(73) Assignee: Atigeo Corporation, Bellevue, WA (US)

(21) Appl. No.: 14/707,989

(22) Filed: May 8, 2015

Related U.S. Application Data
(63) Continuation of application No. PCT/US2013/069271, filed on Nov. 8, 2013.
Application No. PCT/US2013/069271 is a continuation-in-part of application No. 14/221,096, filed on Mar. 20, 2014.
Application No. 14/221,096 is a continuation of application No. 13/484,210, filed on May 30, 2012, now Pat. No. 8,724,963.
Application No. 13/484,210 is a continuation-in-part of application No. 13/043,254, filed on Mar. 8, 2011, now abandoned.
Application No. 13/043,254 is a continuation-in-part of application No. 12/973,677, filed on Dec. 20, 2010, now abandoned.
Application No. 13/484,210 is a continuation of application No. PCT/US2012/033373, filed on Apr. 12, 2012.
Application No. PCT/US2012/033373 is a continuation-in-part of application No. 12/973,677, filed on Dec. 20, 2010, now abandoned.
Application No. 13/043,254 is a continuation-in-part of application No. 12/973,677, filed on Dec. 20, 2010, now abandoned.
(60) Provisional application No. 61/724,501, filed on Nov. 9, 2012.
(60) Provisional application No. 61/785,812, filed on Mar. 14, 2013.
(60) Provisional application No. 61/474,557, filed on Apr. 12, 2011.
(60) Provisional application No. 61/287,817, filed on Dec. 18, 2009.

(51) Int. Cl. G06Q 30/02

(52) U.S. Cl. CPC G06Q 30/0217; G06Q 30/0269

(57) ABSTRACT

Some embodiments include a system. The system includes an engagement module. The engagement module can be at least partially operable on a centralized computer device. The engagement module can communicate with an application module, which can be at least partially operable on a user computer device. Meanwhile, the user computer device can include a user interface. Further, the engagement module can communicate with the application module to solicit via the application module a user to create video content, and the application module can include a user interface module configured to communicate with the user interface to permit the user to communicate with and operate the application module. The centralized computer device can be located remotely from the user computer device, and the centralized computer device can be configured to communicate with the user computer device. Other embodiments of related systems and methods are also disclosed.

### CROSS-REFERENCE TO RELATED APPLICATIONS

This application is a continuation of International Patent Application No. PCT/US2013/069271, filed on Nov. 8, 2013. International Patent Application No. PCT/US2013/069271 claims the benefit of U.S. Provisional Patent Application No. 61/724,501, filed Nov. 9, 2012, and U.S. Provisional Patent Application No. 61/785,812, filed Mar. 14, 2013.

Further, this application is a continuation-in-part of U.S. Non-Provisional patent application Ser. No. 14/221,096, filed on Mar. 20, 2014. U.S. Non-Provisional patent application Ser. No. 14/221,096 is: (i) a continuation application of U.S. Non-Provisional patent application Ser. No. 13/484,210, filed May 30, 2012, which issued as U.S. Pat. No. 8,724,963 on May 13, 2014, (ii) a continuation-in-part application of U.S. Non-Provisional patent application Ser. No. 13/043,254, filed Mar. 8, 2011, and (iii) a continuation-in-part application of U.S. Non-Provisional patent application Ser. No. 12/973,677, filed Dec. 20, 2010.

Meanwhile, U.S. Non-Provisional patent application Ser. No. 13/484,210 is a continuation application of International Patent Application No. PCT/US2012/033373, filed on Apr. 12, 2012, and U.S. Non-Provisional patent application Ser. No. 13/484,210 a continuation-in-part application of U.S. Non-Provisional patent application Ser. No. 12/973,677. Further, International Patent Application No. PCT/US2012/033373 claims the benefit of U.S. Provisional Patent Application No. 61/474,557, filed Apr. 12, 2011; U.S. Non-Provisional patent application Ser. No. 13/043,254 is a continuation-in-part application of U.S. Non-Provisional patent application Ser. No. 12/973,677; and U.S. Non-Provisional patent application Ser. No. 12/973,677 claims the benefit of U.S. Provisional Patent Application No. 61/287,817, filed Dec. 18, 2009.

U.S. Provisional Patent Application No. 61/724,501, U.S. Provisional Patent Application No. 61/785,812, U.S. Provisional Patent Application No. 61/287,817, U.S. Provisional Patent Application No. 61/474,557, U.S. Non-Provisional patent application Ser. No. 12/973,677, U.S. Non-Provisional patent application Ser. No. 13/043,254, U.S. Non-Provisional patent application Ser. No. 13/484,210, U.S. Non-Provisional patent application Ser. No. 14/221,096, International Patent Application No. PCT/US2012/033373, and International Patent Application No. PCT/US2013/069271 are each incorporated herein by reference in their entirety.

Further, International Patent Application No. PCT/US2010/061363, filed on Dec. 20, 2010, and International Patent Application No. PCT/US2012/028346, filed on Mar. 8, 2012 also are each incorporated herein by reference in their entirety.

### FIELD OF THE INVENTION

This invention relates generally to a system for enhancing an experience of using a user computer device (e.g., a mobile electronic device and/or a wearable user computer device), and relates more particularly to a system applying gaming mechanics, control, security, privacy, and/or social networking to a user computer device and methods of providing and using the same.

### DESCRIPTION OF THE BACKGROUND

Organizations of all types (e.g., businesses, governments, charities, etc.) regularly implement, modify, and investigate techniques for engaging people for the purpose of furthering their organizational objectives and/or goals. For example, business organizations might engage people in the hope of selling more merchandise or services. Likewise, government organizations might engage people to gain support for proposed legislation and gain voters. Further, charitable organizations might engage people in order to receive donations and to get people to volunteer. Often, user engagement can be as simple as increasing the visibility of an organization to existing customers, affiliates, donors, etc. Further, user engagement can include engaging potential customers, affiliates, donors, etc. Advertising, for example, is one technique organizations frequently implement in an effort to engage people.

One useful, but often overlooked, technique for engaging people can be the creation of user generated video content. For example, viewers of user generated video content including subject matter relating in some manner to an organization can provide increased visibility of that organization to those viewers. Further, the viewers may even view the subject matter of the user generated video content as an endorsement of and/or support for that subject matter by the author of the video content. In turn, the viewers may be inclined to form similar opinions about the subject matter. Where the subject matter and/or opinions are favorable to the organization and its goals and/or where the viewers may know and trust the author of the user generated video content, such user generated video content can be an invaluable source of user engagement. Still, engaging people to create user generated video content in a meaningful way with respect to the organization (i.e., in a way favoring the organization and its objectives and/or goals) can be difficult. Gamification, which can refer to the application of game mechanics to non-game contexts, can provide a way to engage people in a meaningful way, but up until now, has not been applied to the creation of user generated video content.

Meanwhile, integrating gamification techniques with the emerging technologies of mobile electronic devices and/or wearable computer devices (e.g., head mountable wearable computer devices) can provide further opportunities for engaging people for the purpose of furthering organization objections and/or goals. Wearable computer devices, in particular, also can provide opportunities to encourage human behaviors and social interactions.

### BRIEF DESCRIPTION OF THE DRAWINGS

To facilitate further description of the embodiments, the following drawings are provided in which:

FIG. 1 illustrates a system, according to an embodiment;

FIG. 2 illustrates a system, according to another embodiment;

FIG. 3 illustrates a flow chart for an embodiment of a method of manufacturing a system;

FIG. 4 illustrates a flow chart for an exemplary activity of manufacturing an application module, according to the embodiment of FIG. 3;

FIG. 5 illustrates a flow chart for an exemplary activity of configuring the application module to communicate with an engagement module, according to the embodiment of FIG. 3;

FIG. 6 illustrates a flow chart for another embodiment of a method of manufacturing a system;

FIG. 7 illustrates a flow chart for an exemplary activity of manufacturing an engagement module, according to the embodiment of FIG. 6;

FIG. 8 illustrates a flow chart for another embodiment of a method;

FIG. 9 illustrates a flow chart for an exemplary activity of soliciting a user to create video content, according to the embodiment of FIG. 8;

FIG. 10 illustrates a flow chart for an exemplary activity of offering one or more incentives to the user in order to solicit the user to create the video content, according to the embodiment of FIG. 8;

FIG. 11 illustrates a flow chart for an exemplary activity of soliciting the user to perform one or more user actions regarding the video content, according to the embodiment of FIG. 8;

FIG. 12 illustrates a computer system that is suitable for implementing an embodiment of a user computer system and/or a centralized computer device of the embodiments of the systems of FIGS. 1 and/or 2 and/or the methods of FIGS. 3, 6, and/or 8;

FIG. 13 illustrates a representative block diagram of an example of the elements included in the circuit boards inside chassis of the computer of FIG. 12;

FIG. 14 illustrates a flow chart for another embodiment of a method;

FIG. 15 illustrates a flow chart for an exemplary activity of receiving one or more social settings from a user of a first application module; and

FIG. 16 illustrates a flow chart for another embodiment of a method.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION OF EXAMPLES OF EMBODIMENTS

Some embodiments include a system. The system comprises an application module. The application module can be at least partially operable on one or more user processing modules of a user computer device and at least partially storable in one or more non-transitory user memory storage modules of the user computer device. Meanwhile, the user computer device can comprise a user interface. Further, the application module can comprise a user interface module configured to communicate with the user interface to permit the user to communicate with and operate the application module. Further still, the application module can be configured to communicate with an engagement module, and the engagement module can be configured to solicit via the application module the user to create video content.

Various embodiments include a system. The system comprises an engagement module. The engagement module can be at least partially operable on one or more centralized processing modules of a centralized computer device and at least partially storable at one or more non-transitory centralized memory storage modules of the centralized computer device. The engagement module can be configured to communicate with an application module, which can be at least partially operable on one or more user processing modules of a user computer device and at least partially storable in one or more non-transitory user memory storage modules of the user computer device. Meanwhile, the user computer device can comprise a user interface. Further, the engagement module can be configured to communicate with the application module to solicit via the application module a user to create video content, and the application module can comprise a user interface module configured to communicate with the user interface to permit the user to communicate with and operate the application module. Further still, the centralized computer device can be located remotely from the user computer device, and the centralized computer device can be configured to communicate with the user computer device.

Further embodiments include a method of manufacturing a system. The method comprises manufacturing an application module, where the application module can be at least partially operable on one or more user processing modules of a user computer device and at least partially storable in one or more non-transitory user memory storage modules of the user computer device, and where the user computer device can comprise a user interface. Meanwhile, manufacturing the application module can comprise: manufacturing a user interface module of the application module, the user interface module being configured to communicate with the user interface to permit a user to communicate with and operate the application module; and configuring the application module to communicate with an engagement module, the engagement module being configured to solicit via the application module the user to create video content.

Many embodiments include a method of manufacturing a system. The method comprises manufacturing an engagement module, where the engagement module can be at least partially operable on one or more centralized processing modules of a centralized computer device and at least partially storable at one or more non-transitory centralized memory storage modules of the centralized computer device, and where the centralized computer device can be located remotely from the user computer device and can be configured to communicate with a user computer device comprising a user interface. Meanwhile, manufacturing the engagement module can comprise: configuring the engagement module to communicate with an application module, the application module (i) being at least partially operable on one or more user processing modules of the user computer device and at least partially storable in one or more non-transitory user memory storage modules of the user computer device, and (ii) comprising a user interface module configured to communicate with the user interface to permit a user to communicate with and operate the application module; and configuring the engagement module to solicit via the application module the user to create video content.

Other embodiments include a method. At least part of the method can be implemented via execution of computer instructions configured to run at one or more user processing modules of a user computer device and configured to be stored in one or more non-transitory user memory storage modules of the user computer device. Meanwhile, the user computer device can comprise a user interface. The method can comprise: executing one or more first computer instructions configured to solicit a user to create video content; and executing one or more second computer instructions configured to receive the video content from the user. Meanwhile, the computer instructions can comprise the one or more first computer instructions and the one or more second computer instructions.

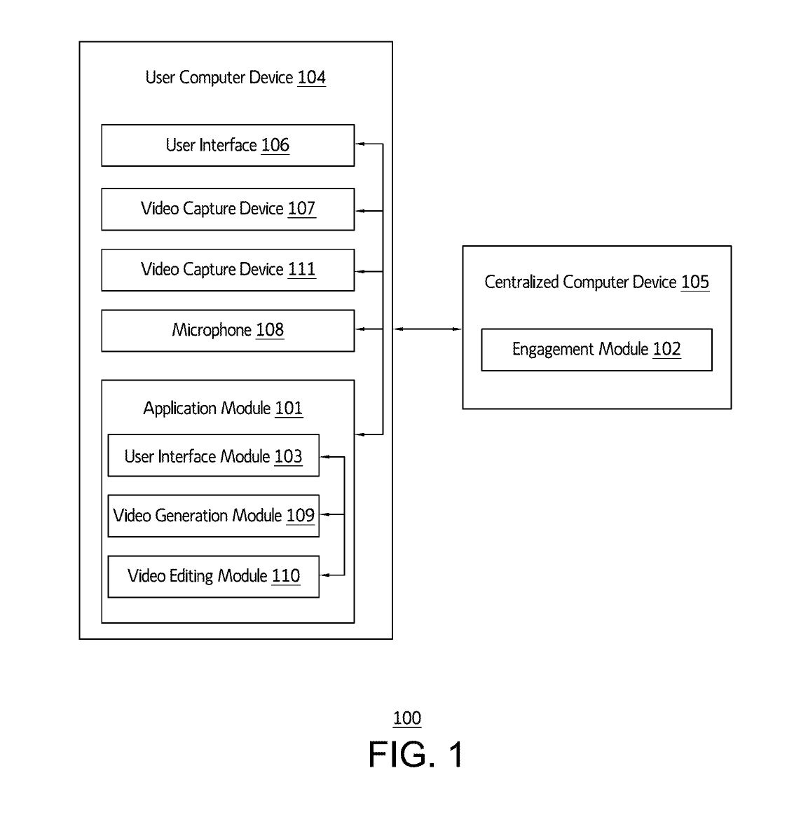

Turning to the drawings, FIG. 1 illustrates system 100, according to an embodiment. System 100 is merely exemplary and is not limited to the embodiments presented herein. System 100 can be employed in many different embodiments or examples not specifically depicted or described herein.

As an introductory matter, system 100 can be implemented to apply gaming mechanics to user generated video content (e.g., recorded video content), such as, for example, by soliciting and incentivizing creation of user generated video content (e.g., recorded video content) and other related user actions (i.e., in order to gamify the creation of user generated video content and other related user actions). As described in detail below, system 100 can be implemented with various software and/or hardware elements. Also described in detail below, application module 101 of system 100 can be affiliated with an organization (e.g., a business, a government, a charity, etc.) to engage a user of application module 101, and other people in many examples, in a way that is meaningful to that organization (i.e., in a way that furthers one or more goal(s) and/or objective(s) of that organization).

In implementation, system 100 comprises application module 101. Further, system 100 can comprise engagement module 102. Application module 101 comprises user interface module 103. As described below, in some embodiments, application module 101 also can comprise engagement module 102. However, in many embodiments and as illustrated at FIG. 1, engagement module 102 can be separate from and/or located remotely from application module 101. Meanwhile, in some embodiments, system 100 can comprise user computer device 104 and/or centralized computer device 105, which can comprise engagement module 102. Still, in other embodiments, centralized computer device 105 can be omitted. User computer device 104 comprises user interface 106. In some embodiments, user computer device 104 also can comprise video capture device 107, microphone 108, and/or application module 101. In these embodiments, user computer device 104 can also comprise video capture device 111. In other embodiments, video capture device 111 can be omitted.

In some embodiments, application module 101 can comprise video generation module 109. Further, application module 101 also can comprise video editing module 110. In other embodiments, video generation module 109 and/or video editing module 110 can be omitted, as described further below.

Although, for simplicity of illustration, system 100 is primarily described herein as being implemented with respect to a single application module (e.g., application module 101) and/or a single user computer device (e.g., user computer device 104), in many examples, system 100 can be implemented using multiple application modules and/or multiple user computer devices, as described in greater detail below. Indeed, in some instances, the efficacy of certain aspects of system 100 (e.g., those aspects based on analytics) can depend on the quantity of application modules and/or user computer devices being implemented as part of system 100.

In many examples, application module 101 can be implemented as software (e.g., application software). Application module 101 can be partially or fully operable on one or more user processing modules and/or storable in one or more user memory storage modules (e.g., one or more non-transitory user memory storage modules) of user computer device 104. Meanwhile, application module 101 also can be partially operable on one or more centralized processing modules and/or storable in one or more centralized memory storage modules (e.g., one or more non-transitory centralized memory storage modules) of centralized computer device 105. In these latter embodiments, application module 101 can be operable in a cloud computing capacity where the centralized processing module(s) run at least part of application module 101 and/or where the centralized storage module(s) store at least part of application module 101.

Further, in these or other examples, engagement module 102 also can be implemented as software. Like application module 101, engagement module 102 can be partially or fully operable on the user processing module(s) and/or storable in the user memory storage module(s) of user computer device 104. However, generally, application module 101 can be at least partially if not fully operable on the centralized processing module(s) and/or storable in the centralized memory storage module(s) of centralized computer device 105. In many examples, centralized computer device 105 can comprise processing and/or storage capacity exceeding that of user computer device 104, and in these or other examples, engagement module 102 can comprise processing and/or storage demands exceeding those of application module 101. Therefore, at least partially or fully operating engagement module 102 at the centralized processing module(s) and/or storing engagement module 102 at the centralized memory storage module(s) of centralized computer device 105 can be more practical than operating engagement module 102 at the user processing module(s) and/or storing engagement module 102 at the user memory storage module(s) of user computer device 104. Further, operating and/or storing engagement module 102 at centralized computer device 105 can also facilitate support, administration, and/or data management of application module 101 and/or engagement module 102 by one or more back end administrators. Still, in other examples, application module 101 and/or engagement module 102 can be operable and/or storable according to any arrangement suitable for the particular implementation of system 100 and/or the relevant processing and/or storage capacities of user computer device 104 and/or centralized computer device 105.

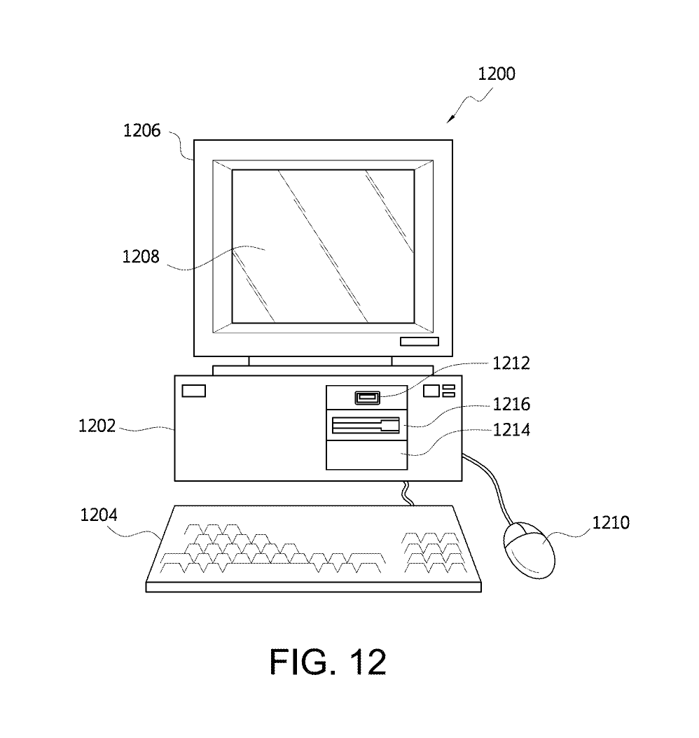

In general, user computer device 104 can comprise any suitable computer system operable by a front end user of application module 101, and centralized computer device 105 can comprise one or more suitable computer systems operable by and/or administrated by one or more back end administrators of application module 101 and/or engagement module 102. Accordingly, in specific examples, user computer device 104 can comprise a desktop computer device, a wearable user computer device, a mobile electronic device, and/or any other suitable computer device configured to operate and/or store application module 101 and/or engagement module 102. Meanwhile, centralized computer device 105 can comprise one or more computer systems (e.g., one or more computer servers) configured to support, administrate, and/or data manage application module 101 and/or engagement module 102. At least part of centralized computer device 105 can be located remotely from user computer device 104. Notably, as indicated above, although centralized computer device 105 can be operated and/or administrated by a single back end administrator, in practical implementation, centralized computer device 105 can be operated and/or administrated by multiple back end administrators, such as, for example, where one or more primary administrators contract with one or more subordinate administrators (e.g., server operators, managers, analysts, etc.) to implement the back end functionality of system 100 (i.e., the functionality of engagement module 102). Accordingly, user computer device 104 and/or centralized computer device 105 can each be similar or identical to computer system 1200 (FIG. 12), as described below.

Further, the term “mobile electronic device” as used herein can refer to a portable electronic device (e.g., an electronic device easily conveyable by hand by a person of average size) with the capability to present audio and/or visual data (e.g., images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For examples, in some embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

In specific examples, a mobile electronic device can comprise the iPod® or iPhone® or iTouch® or iPad® or MacBook® or similar product by Apple Inc. of Cupertino, Calif., United States of America. Likewise, a mobile electronic device can comprise a Blackberry® or similar product by Research in Motion (RIM) of Waterloo, Ontario, Canada, a Lumia or similar product by the Nokia Corporation of Keilaniemi, Espoo, Finland, a Galaxy or similar product by the Samsung Group of Samsung Town, Seoul, South Korea, or a different product by a different manufacturer. Further, in the same or different embodiments, a mobile electronic device can comprise an electronic device configured to implement one or more of the iPhone® operating system by Apple Inc. of Cupertino, Calif., United States of America, the Blackberry® operating system by Research In Motion (RIM) of Waterloo, Ontario, Canada, the Palm® operating system by Palm, Inc. of Sunnyvale, Calif., United States, the Android operating system developed by the Open Handset Alliance, the Windows Mobile operating system by Microsoft Corp. of Redmond, Wash., United States of America, or the Symbian operating system by Nokia Corp. of Keilaniemi, Espoo, Finland.

Further still, the term “wearable user computer device” as used herein can refer to an electronic device with the capability to present audio and/or visual data (e.g., images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

A wearable user computer device and/or a mobile electronic device can be operable to augment a reality of a user of the wearable user computer device and/or mobile electronic device. In these or other examples, a wearable user computer device can augment a reality of the user in a manner that does not interfere with and/or detract from, or otherwise minimally interferes with and/or detracts from, the reality of the user. In some examples, a wearable user computer device can be operable while one or both hands and/or one or both feet of a user of the wearable user computer device remain free for other use. In these or other examples, a wearable user computer device can be operable while the user's vision is primarily focused on something else.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass or a similar product by Google Inc. of Menlo Park, Calif., United States of America; (ii) the Eye Tap, the Laser Eye Tap, or a similar product by ePI Lab of Toronto, Ontario, Canada, and/or (iii) the Raptyr, the STAR 1200, the Vuzix Smart Glasses M100, or a similar product by Vuzix Corporation of Rochester, N.Y., United States of America. In other specific examples, a head mountable wearable user computer device can comprise the Virtual Retinal Display, or similar product by the University of Washington of Seattle, Wash., United States of America. Meanwhile, in further specific examples, a limb mountable wearable user computer device can comprise the iWatch, or similar product by Apple Inc. of Cupertino, Calif., United States of America.

Referring briefly to video capture device 107 and video capture device 111, video capture device 107 and/or video capture device 111 can each comprise one or more cameras. In some embodiments, at least one of the camera(s) can comprise an infrared camera, such as, for example, for operation in low levels of visible light. According to convention, video capture device 107 can be configured and/or intended for use as an outward facing video capture device, and/or video capture device 111 can be configured and/or intended for use as an inward facing video capture device. The terms “outward facing” and “inward facing” can be from a perspective of a user of user computer device 104. Thus, when operated as intended, video capture device 107 can be aimed generally away from the user and video capture device 111 can be aimed generally toward the user. However, because in many examples, user computer device 104 can remain operable when reoriented, the terms “outward facing” and “inward facing” are intended to be illustrative and not to be read as limiting. Notwithstanding the foregoing, in other examples, such as when user computer device 104 comprises a mountable wearable user computer device, user computer device 104 may not be subject to reorientation while in operation. Thus, this convention can apply more readily. Described another way, in many examples, video capture device 107 and/or video capture device 111 can be configured to face generally opposite directions.

Accordingly, in many examples, when a head mountable wearable user computer device is mountable in close proximity to one or both eyes of a user of the head mountable wearable user computer device and/or vectored in alignment with a field of view of the user, video captured by video capture device 107 can approximately represent what the user is presently seeing or would be seeing with the one or both eyes. Meanwhile, video capture device 111 can be focused on the one or both eyes, such as, for example, to detect changes and/or movement of the one or both eyes. Accordingly, video capture device 107 can provide point-of-view video content and/or video capture device 111 can permit gesture-based control of user computer device 104 and/or application module 101, both concepts of which will be elaborated upon further below.

Focusing back on computer device 104 and centralized computer device 105, user computer device 104 and centralized computer device 105 can be configured to communicate with each other according to any one or any combination of wired and/or wireless network topologies (e.g., bus, star, tree, line, ring, mesh, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.), as appropriate and/or desirable. Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3, IEEE 802.11, etc.; and exemplary cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/Time Division Multiple Access (TDMA)), Integrated Digital Enhanced Network (iDEN), etc. The components implementing the wired and/or wireless communication can be dependent on the network topologies and/or protocols in use, and vice versa. Further, as applicable, user computer device 104 can also be configured to communicate with one or more other user computer devices using the same or different wired and/or wireless network topology(ies) and/or protocol(s).

Meanwhile, in some examples, when user computer device 104 lacks the capability to communicate via one or more wired and/or wireless network topology(ies) and/or protocol(s), user computer device 104 can be paired and/or tethered with another computer device having the capability to communicate via the lacking wired and/or wireless network topology(ies) and/or protocol(s). In these examples, the other computer devices can be similar to user computer device 104, but can also comprise hardware configured to communicate with user computer device 104 and to communicate via the lacking wired and/or wireless network topology(ies) and/or protocol(s). In a specific example, when user computer device 104 comprises a wearable user computer device, user computer device 104 may be configured to communicate via personal area network (PAN) protocol(s), local area network (LAN) protocol(s), and/or wide area network (WAN) protocol(s) but may not be configured to communicate via cellular network protocol(s). Accordingly, user computer device 104 could be paired and/or tethered with another computer device (e.g., a smart phone mobile electronic device) capable of communicating via cellular network protocol(s) to permit user computer device 104 to also communicate via those cellular network protocol(s).

Further, application module 101 and engagement module 102 are configured to communicate with each other. To the extent that application module 101 and engagement module 102 are operated and/or stored separately at user computer device 104 and centralized computer device 105, respectively, application module 101 and engagement module 102 can communicate with each other through the communication of user computer device 104 and centralized computer device 105 with each other. Meanwhile, to the extent that application module 101 and engagement module 102 are operated and/or stored together at user computer device 104 and/or centralized computer device 105, application module 101 and engagement module 102 can communicate with each other through system calls to the computer operating systems corresponding to user computer device 104 and/or centralized computer device 105. However, because in some examples, centralized computer device 105 can comprise multiple computer systems, it is also possible that the multiple computer systems of centralized computer device 105 communicate with each other in similar or identical manner to the communication between user computer device 104 and centralized computer device 105, even where application module 101 and engagement module 102 are operated and/or stored together at centralized computer device 105, as parts of the operation and/or storage of application module 101 and/or engagement module 102 can be spread throughout the multiple computer systems. Meanwhile, as applicable, application module 101 can also be configured to communicate with one or more other application modules corresponding to one or more other user computer devices than user computer device 104. In these examples, as indicated above, application module 101 and the other application module(s) can communicate with each other via communication of user computer device 104 with one or more other user computer devices corresponding to the other application modules.

In many examples, such as when user computer device 104 comprises a mobile electronic device, application module 101 can comprise a mobile electronic device software application. In these embodiments, application module 101 can be integrated with another mobile electronic device software application (e.g., a social networking mobile electronic device software application, such as, for example, the Facebook mobile electronic device software application of Facebook, Inc. of Menlo Park, Calif., United States of America, the Twitter mobile electronic device software application of Twitter, Inc. of San Francisco, Calif., United States of America, the Pinterest mobile electronic device software application of Pinterest, Inc. of San Francisco, Calif., United States of America, and/or the Path mobile electronic device software application of San Francisco, Calif., United States of America, etc.) and/or can be independent, as is described in greater detail below. In other examples, application module 101 can comprise a web application. Accordingly, in these examples, application module 101 can be embedded in any suitable website.

In general, video capture device 107 and/or video capture device 111 can be operable to capture and store (e.g., record) video content as recorded video content. However, in some examples, video capture device 107 and/or video capture device 111 can also be operable to capture video content as streaming video content, such as, for example, to be viewed as a live feed (e.g., approximately in real-time) by the user of user computer device 104 and/or application module 101 via user interface 106. In many examples, recorded video content, which can conventionally be stored at one or more non-transitory memory storage modules of user computer system 104 and/or centralized computer system 105, can be distinguished from streaming video content, which can conventionally be stored (e.g., temporarily) at one or more transitory memory storage modules of user computer system 104 and/or centralized computer system 105, in that recorded video content can be viewed again later while streaming video content cannot. Nonetheless, in practice, video capture device 107 and/or video capture device 111 may create the recorded video content and streaming video content from the same feed, such as, for example, by moving streaming video content from one or more transitory memory storage modules of user computer system 104 and/or centralized computer system 105 to one or more non-transitory memory storage modules of user computer system 104 and/or centralized computer system 105.

Next, user interface module 103 is configured to communicate with user interface 106 to permit a user of application module 101 to communicate with and operate application module 101 through user interface 106. As indicated previously, user computer device 104 comprises user interface 106. User interface 106 can comprise one or more components that permit a user to operate user computer device 104 and/or permit communication between the user and user computer device 104. For example, user interface 106 can comprise one or more controls (e.g., one or more buttons, a keyboard, a keypad, a scroll ball, a mouse, etc.), one or more electronic displays (e.g., a touch screen electronic display, a flat panel electronic display, and/or a real-time electronic display, etc.), one or more speakers, one or more microphones (e.g., microphone 108), one or more cameras (e.g., video capture device 107 and/or video capture device 111), one or more sensors (e.g., one or more accelerometers, one or more solid-state compasses, one or more global positioning systems, one or more personal area network communication systems such as Blue Tooth personal area network communication system(s), one or more near field communication systems, etc.), etc. The term “real-time electronic display” can refer to an electronic display that is configured to receive and display (e.g., continuously, while activated) streaming video content from video capture device 107 and/or video capture device 111 for live viewing by the user of user computer device 104.

For purposes of clarity, in some examples, an individual electronic display can comprise a touch screen electronic display, a flat panel electronic display, and/or a real-time electronic display. In many examples, when user interface 106 comprises an electronic display, user interface module 103 can be configured to display a graphical user interface at the electronic display in order to communicate with the user of application module 101. Where applicable, such as, for example, when the electronic display comprises a touch screen electronic display and/or a real-time electronic display, the graphical user interface can be interactive (e.g., displaying and responding to inputs provided at the touch screen electronic display). In some examples, user interface 106 can superimpose part or all of the graphical user interface over other content displayed at the electronic display. Superimposing the graphical user interface can be particularly advantageous when the electronic display comprises a real-time electronic display because the graphical user interface can be aligned and/or associated with the streaming video content, as elaborated upon below.

As much as user interface module 103 operates to interface a user of application module 101 with application module 101 using user interface 106 of user computer device 104 as a medium of communication exchange, engagement module 102 can be responsible for engaging the user of application module 101, such as, for example, through the use of gaming mechanics. As a result of engagement module 102 and as described in greater detail below, an organization (e.g., a business, a government, a charity, etc.) can implement system 100 and/or one or more application modules (e.g., application module 101) in order to further its objectives and/or goals as an organization. For example, using gamification techniques provided by engagement module 102, system 100 and/or application module 101 can engage users in a meaningful way to create user generated video content (e.g., recorded video content) and perform one or more other user actions regarding the video content (e.g., recorded video content) in order to further the objectives and/or goals of the organization.

Specifically, engagement module 102 can be configured to solicit (e.g., request) a user of application module 101 to create video content. Although the solicited video content can generally comprise recorded video content, in some examples, the video content can also comprise streaming video content. Indeed, in some examples, engagement module 102 can indicate and/or make clear to the user whether or not the video content is to be recorded video content or whether streaming video content is sufficient. The video content (e.g., recorded video content) can comprise audio and/or visual media content.

Engagement module 102 can solicit the user to create the video content (e.g., recorded video content) according to any suitable level of detail. For example, in some embodiments, in a lower level of detail, engagement module 102 can solicit the user to create video content (e.g., recorded video content) according to the user's complete discretion. However, in other embodiments, in a higher level of detail, engagement module 102 can solicit the user to create video content (e.g., recorded video content) according to one or more predetermined parameters. These parameters can generally be any suitable parameters, but can also be determined based on analytics calculated by engagement module 102, as described below, and/or tailored according to an organization with which application module 101 is affiliated, as also described below.

Exemplary parameters can include requests for one or more specific types of content, one or more specific actions, one or more video lengths, a quantity and/or class of participants, a location, a time, the use of one or more props, etc. Further exemplary parameters can include requests that the video content be created within a predetermined distance of a target of interest, that the video content comprises point-of-view video content, and/or that the video content includes one or more targets of interest. In these examples, the target of interest could be identified as part of the request. A target of interest can be any suitable specimen that can be captured in the video content. However, exemplary targets of interest can comprise any suitable media content (e.g., a commercial, a television show, a movie, etc.), a product, a product display, a product or company logo, a product packaging, a company house mark, an advertisement, etc. Notably, target(s) of interest do not necessarily have to be stationary or three-dimensional objects. For example, as indicated, engagement module 102 could solicit creation of video content comprising other audio and/or visual media content (e.g., other video content). Further, the target(s) of interest can even be purely audio media content, such as, for example, music.

As used herein, the term “point-of-view video content” can refer to video content created from a point of view of the author of the video content (e.g., the user of application module 101). As introduced above, point-of-view video content can approximate that which the author of the video content is or would be seeing at the time of creating the video content. Frequently, where user computer device 104 comprises a head mountable wearable user computer device, video content provided thereby can automatically comprise point-of-view video content. Notably, point-of-view video content can provide value to an organization (e.g., a business, a government, a charity, etc.) implementing system 100 and/or one or more application modules (e.g., application module 101) because point-of-view content can provide insight into an intent of the author of the video content. For example, as compared to general video content, point-of-view video content is more likely to show that on which the author of the video content is primarily focusing. Further, point-of-view video content can make it possible to gauge the interest of the author and/or the deemed importance given by the author in a particular specimen and/or relative to another specimen. For example, point-of-view video content can make clear how much time the author focuses on a particular specimen (versus another) and/or the number of times the author refocuses on a particular specimen (versus another).

These parameters can help to ensure that the user generated video content engages the user in a meaningful way. In a specific example, engagement module 102 can solicit the user to create recorded video content based on the user's first drink at a bar that Friday evening. Thus, the parameters can comprise a prop, a day, a time, and a place. Engagement module 102 could also request that the video content include the first drink of a friend of the opposite sex of the user of application module 101 that evening, thus including participant and class parameters.

In another specific example, engagement module 102 can establish a target of interest (e.g., a display for a particular brand of deodorant) and can solicit the user to create recorded video content within two meters of that target of interest. In these examples, in order to establish the distance between the target of interest and the location where the recorded video content was created, engagement module 102 can determine a geographic location of the target of interest and compare that against a geo-tag of the created recorded video content, the latter concept of which is explained in greater detail below. Further, in these or other specific examples, engagement module 102 can solicit the user to create the recorded video content as point-of-view recorded video content. In these examples, in order to establish whether the target of interest was properly within the point-of-view recorded video content created, engagement module 102 can reference a point-of-view tag of the created recorded video content in conjunction with the geographic location of the target of interest and the geo-tag of the created recorded video content. Like for geo-tagging, point-of-view tagging is explained in greater detail below. In these specific examples, if the video content were to comprise streaming video content, engagement module 102 could, in some embodiments, reference a position of user computer device 104 (e.g., via global positioning and/or indoor positioning) as opposed to referencing a geo-tag of the video content.

In many embodiments, application module 101 and/or engagement module 102 can be configured to identify whether one or more targets of interest are present within video content. For example, this functionality can be implemented when engagement module 102 solicits the user to create video content with the parameter that the video content includes one or more targets of interest. Accordingly, in some embodiments, application module 101 and/or engagement module 102 can be configured to perform object recognition within the video content, such as, for example, by applying an image recognition algorithm to the video content. In some examples, the object recognition can include optical character recognition, such as, for example, when the target(s) of interest include text (e.g., alpha-numeric text). In other examples, object recognition can include physical objects, symbols, images, colors, etc. In further embodiments, object recognition can also include code recognition, such as, for example, when the target(s) of interest include a coded object such as a linear (e.g., Universal Product Code) or matrix barcode (e.g., Quick Response (QR) Code) or another system of identification.

In operation, engagement module 102 can solicit a user of application module 101 to create video content by communicating visual and/or auditory requests and/or cues for the video content, and any corresponding parameters regarding the video content when applicable, to the user via user interface module 103 and user interface 106. For example, user interface module 103 can display a request for video content at an electronic display of user interface 106 soliciting the user of application module 101 to create video content. Further, engagement module 102 can also communicate with the user through other communication mediums, such as, for example, electronic mail, text message, instant message, automated telephone call, etc. In these embodiments, engagement module 102 can directly provide the solicitation for user generated video content via the other communication medium(s), or engagement module 102 can indirectly solicit creation of the video content by inviting the user to reference application module 101 via the other communication medium(s) and then providing the solicitation at user interface 106.

As introduced above, when user interface 106 comprises a real-time electronic display, user interface module 103, in communication with engagement module 102, can superimpose visual requests and/or cues, and any other suitable information whether or not related to the visual request and/or cues, directly over the streaming video content, such as, for example, via a graphical user interface of the real-time electronic display. In particular, the visual requests and/or cues can be aligned with and/or associated with specific target(s) of interest in the streaming video content. This alignment and/or association can make clear to the user which visual request and/or cue applies to which target of interest. The superimposed information can also be scaled in size respective to the visible size of the target(s) of interest. In some examples, user interface module 103 can be configured to superimpose the visual request and/or cue over the target of interest in the streaming video content when the user of user computer device 104 and/or user computer device 104 are located within a predetermined distance of the target of interest and/or are facing the target of interest. Engagement module 102 can determine whether these conditions exist according to the same approaches as described previously regarding the parameters for created video content.

Beyond the context of providing visual requests and/or cues, as indicated above, user interface module 103, in communication with engagement module 102, can also superimpose any other information directly over the streaming video content, as desirable. For example, when a particular target of interest comprises a product, user interface module 103 can superimpose prices, product specifications (e.g., dimensions, weight, materials of manufacture, ingredients, nutritional information, shelf life, etc., as applicable), the name, contact information, and/or other information for the manufacturer of the product, product reviews, comparison products, comparison prices, related products, alternative retail locations, price history, product warnings, product recalls, expiration dates, coupons, sales, etc., as applicable. Further, user interface module 103 can also superimpose one or more hyperlinks relevant to the target(s) of interest. Accordingly, the user of user computer system 104 can choose to follow the hyperlink(s), thereby accessing the Internet, to obtain additional information related to the target(s) of interest.

As explained previously, the target(s) of interest could be a physical product, such as, for example, at a brick and mortar retail store, and/or could be a digital image of the product, such as, for example, displayed at an electronic display. Accordingly, in the context of shopping applications, this functionality of user interface module 103 and/or engagement module 102 can apply readily to brick and mortar and/or online shopping situations. Further, the target(s) of interest could be part of a television and/or movie image. For example, user interface module 103 could superimpose information about the clothing being worn in the television and/or movie image, such as, for example, to let the user of user computer device 104 know retailers for the clothing.

In many examples, in operation, the user of user computer device 104 can operate user interface 106 to toggle between and/or to select information superimposed over the streaming video content by user interface module 103. Further, when multiple details of information are provided for a target of interest, user interface module 103 can cycle between the multiple details of information. However, in other examples, the superimposed information can be statically displayed and/or can be non-interactive.

In addition to soliciting the creation of user generated video content, engagement module 102 can also solicit the user to perform one or more user actions regarding the video content. As a general matter, engagement module 102 can solicit any suitable user action(s) that can engage the user and/or one or more other people in a meaningful way for the organization (e.g., in a way to further the goal(s) and/or objective(s) of the organization) affiliated with application module 101. In many examples, engagement module 102 can solicit the user to perform the user action(s) regarding the video content after soliciting the user to create the video content and/or after the user creates and/or submits the video content. In various embodiments, application module 101 and/or user interface module 103 can be configured to permit the user to perform the one or more user actions regarding the video content.

Exemplary user actions can comprise (i) identifying one or more locations of the video content (i.e., location(s) where the video content was made), (ii) identifying one or more times of the video content (i.e., time(s) that the video content was made), (iii) identifying one or more dates of the video content (i.e., date(s) on which the video was made), (iv) identifying one or more participants of the video content (i.e., one or more people in the video content), (v) commenting on, summarizing, and/or identifying the substantive content of the video, and/or (vi) identifying one or more points-of-view of the video content. In many examples, these user actions can help engage other people by making the video content more easily searchable by other people, increasing the likelihood that other people will be exposed to the video content. Likewise, these user actions can make the video content more interesting and/or appealing to other people, also increasing the likelihood that other people will be exposed to and/or engaged by the video content. In some examples, the location(s), time(s), date(s), participant(s) and/or one or more summaries can be applied to and/or associated with the video content, such as, for example, using metadata and/or labels. Accordingly, in many examples, performing these user actions can comprise tagging the video content. For example, tagging the video content with location(s) can be referred to as geo-tagging. In particular, geo-tagging can refer to associating the video content and/or part of the video content with metadata providing a geographic location of where the video content or that part of the video content was created, such as, for example, in terms of a geographic coordinate system or an indoor positioning system. An exemplary indoor positioning system can comprise iBeacon developed and maintained by Apple Inc. of Cupertino, Calif., United States of America. U.S. patent application Ser. No. 12/973,677, filed Dec. 20, 2012, and/or U.S. patent application Ser. No. 13/043,254, filed Mar. 8, 2011, describe exemplary techniques for applying and/or associating location(s), time(s), date(s), participant(s) and/or one or more summaries with the video content. Accordingly, U.S. patent application Ser. No. 12/973,677 and U.S. patent application Ser. No. 13/043,254 are incorporated herein by reference in their entirety. Meanwhile, tagging the video content with point(s)-of-view can refer to associating the video content and/or part of the video content with metadata providing a directionality in which the video content or that part of the video content was created, such as, for example, in terms of a Cartesian and/or spherical coordinate system.

Further exemplary user actions can comprise (a) endorsing the video content, (b) sharing the video content, and/or (c) locating (e.g., searching for) video content (e.g., similar video content). In many examples, these user actions can help engage other people to the video content (e.g., through collaboration) by making the video content available to other people and/or by encouraging the user and/or other people to view additional video content.

Endorsing the video content can refer to providing one or more indications of approval and/or support for the video content and/or the substantive content of the video content.

Sharing the video content can refer to making the video content (e.g., recorded video content and/or streaming video content) available to one or more other people, such as, for example, via one or more social networking and/or video sharing services, electronic mail, video messaging, etc. In some embodiments, the user can also share the video content with users of other application modules of system 100 and/or user computer devices of system 100. In these embodiments, application module 101 can be configured to send and/or receive video content to and/or from other application modules of system 100 and/or user computer devices of system 100, directly, and/or indirectly using centralized computer system 105 as an intermediary. In further embodiments, engagement module 102 can be configured to maintain a video content database to which the user can upload recorded video content so as to make it available to other users of other application modules of system 100. In these or other embodiments, engagement module 102 can be configured to notify one or more other users of other application module(s) of system 100 (e.g., via other user interface(s) at other user computer system(s) operating the other application module(s)) that the user has uploaded recorded video content to the video content database. Further, in some embodiments, upon receiving such notifications, the application module(s) of system 100 and/or engagement module 102 can be configured so that the other users can comment, tag, etc. the uploaded recorded video content.

Meanwhile, locating video content (e.g., similar video content) can refer to searching for other video content similar and/or related to particular video content (e.g., sharing similar or identical metadata), and/or searching for some or all video content authored by a person. More specifically, in some examples, locating video content can refer to searching for video content in any suitable database external from system 100, such as, for example, using any suitable external search engine. In these or other examples, locating video content can also or alternatively refer to searching for video content at an internal database of system 100, such as, for example, the database referenced above with respect to sharing the video content. Accordingly, in many examples, application module 101 can be configured so as to provide the user access to external and/or internal search engines for locating the video content. Among any other suitable search parameters, in many examples, suitable search parameters can comprise searching according to similar location(s), time(s), date(s), participant(s), author(s), and/or substantive content(s) of the created video content.

U.S. patent application Ser. No. 13/484,210, filed May 30, 2012, describes exemplary techniques for locating other video content that can be applied to external and/or internal searches for locating the other video content. U.S. patent application Ser. No. 13/484,210 is incorporated herein by reference in its entirety. For example, video content can be located using gesture-based searching techniques as described in U.S. patent application Ser. No. 13/484,210. In particular, gesture(s) can comprise one or more sensor-based inputs having search commands associated therewith.

Accordingly, in examples when user interface 106 comprises a real-time electronic display and video capture device 107 is configured to perform object recognition, application module 101 and/or user interface module 103 can be configured to recognize gesture(s) of the user's hand(s) captured in streaming video content provided by video capture device 107. In these examples, the hand gesture(s) themselves can be associated with search commands. In these or other examples, the hand gesture(s) can also, or alternatively, be associated with search commands in relation to interaction with a graphical user interface provided by user interface module 103. In a specific example of the former scenario, the sole act of pointing the hand in a particular direction could be associated with a search command. Meanwhile, in a specific example of the latter scenario, the act of circling an icon associated with a search command on the graphical user interface could have the result of causing the icon to be selected.

In further examples, when video capture device 111 is configured to provide streaming video content and to perform object recognition, application module 101 and/or user interface module 103 can be configured to recognize gesture(s) of the user's eye(s), captured in streaming video content provided by video capture device 111, as search commands. Exemplary gesture(s) of the eye(s) can comprise movement(s) of the eyeball(s), dilation of the pupil(s), and/or blink(s). For example, application module 101 and/or user interface module 103 can be configured to compare and detect changes in the position of the pupil(s) and/or iris(es) and/or size of the pupil(s) over time. Further, application module 101 and/or user interface module 103 can distinguish between voluntary blinks (e.g., commands) and involuntary blinks (e.g., non-commands) by timing a length of time of the blink. In these examples, blinks lasting for a predetermined length of time can be treated as voluntary blinks.

In other examples, application module 101 and/or user interface module 103 can be configured to recognize teeth clicks, movements of the head, etc. as gesture(s) associated with search commands.

Although the foregoing gesture-based commands are described with respect to search commands, in some embodiments, application module 101 and/or user interface module 103 can be configured to recognize gesture-based commands, such as those described above, to control user computer device 104 and/or application module 101 generally. Indeed, in some examples, application module 101 and/or user interface module 103 can be configured to recognize the gesture-based commands even in embodiments when system 100 is not also configured to provide gamification functionality, and/or other functionality described herein.

Further, in some embodiments, application module 101 also can be configured so as to provide the user access to external and/or internal search engines for locating other types of content and/or information. For example, application module 101 can be configured so that the user can search for social networking behavior (e.g., previously visited locations, previous location reviews written, etc.) of him or herself and/or other users of other application modules of system 100. As similarly provided regarding gesture-based commands, in some examples, application module 101 can be configured to provide the user access to external and/or internal search engines for locating other types of content and/or information even in embodiments when system 100 is not also configured to provide gamification functionality, gesture-based control, and/or other functionality described herein.

Returning back now to the concept of solicited user actions related to the video content, other exemplary user actions can comprise viewing the video content of one or more other users of application modules of system 100, ranking the video content of one or more other users of application modules of system 100 (e.g., according to one or more specified criteria), commenting on the video content of one or more other users of application modules of system 100, suggesting one or more other users of application modules of system 100 comment on the video content created by the user of mobile application 100, and/or inviting one or more other people that are not users of application modules of system 100 to download and/or use an application module of system 100, etc.

In operation, engagement module 102 can solicit the user action(s) regarding the video content in a manner similar or identical to that employed to solicit the user of application module 101 to create the video content.

Meanwhile, through an application of gaming mechanics, engagement module 102 can offer one or more incentives to the user to encourage the user of application module 101 to create video content and/or to perform the user action(s) related to the video content. By applying gaming mechanics to the solicitations of engagement module 102, the user can be more likely to create the video content and/or to perform the user action(s) related to the video content. In many examples, the more video content the user creates and/or the more user action(s) related to the video content that the user performs can result in a higher engagement of the user. In turn, higher engagement of the user can result in a higher likelihood of furthering the objective(s) and/or goal(s) of an organization affiliated with application module 101. Further, the more video content the user creates and/or the more user action(s) related to the video content that the user performs, the greater the likelihood and number of opportunities resulting that other people can also be engaged as a result of the user's actions.

The incentive(s) offered and/or awarded to the user can comprise one or more awards offered and/or awarded to the user. These awards can be tailored to the desires and/or needs of the organization affiliated with mobile application 100. The award(s) can comprise one or more intrinsic awards and/or one or more extrinsic awards. Generally speaking, the actions and/or achievements of the user of application module 101 can be tracked in any suitable manner, but in many examples, can be tracked according to a number of points assigned to and/or earned with respect to creating user generated video content and/or performing user action(s) related to the video content. In some examples, the points can be transferred to one or more other users of application modules of system 100. In further examples, the incentive(s) can be transferred to one or more other users of application modules of system 100. The value (e.g., of points) attributed to the creation of user generated video content and/or one or more of the user action(s) related to the video content can differ, or in other examples, can be the same. For example, the value attributed to the creation of user generated video content and/or one or more of the user action(s) related to the video content can be determined by analytics calculated by engagement module 102, as described below.

Intrinsic awards can be constructs of system 100 configured to award the user of application module 101 within system 100. In some examples, intrinsic awards can refer to intangible awards and/or dependent awards (e.g., awards that can lose their context outside of system 100). In this way, intrinsic awards can be modeled more closely to the conventions of electronic gaming than extrinsic awards. Exemplary intrinsic awards can comprise badges, trophies, milestones, ranks, levels, access and/or membership in a group and/or team of users, and/or any other suitable indications of social status among the users of mobile applications of system 100. Social status can be expressed, for example, in the form of numeric ranks and/or positional ranks (e.g., newbie, director, lieutenant, captain, general, boss, chief, master, etc.). Further exemplary intrinsic rewards can comprise access to additional and/or exclusive application content (e.g., avatars, virtual goods, application module functionality, solicitation options, incentive options, etc.) of application module 101. Access to additional and/or exclusive content can be provided upon the basis of social status achieved by the user of application module 101. Further still, exemplary intrinsic rewards can comprise making it easier for the user of application module 101 to obtain awards and/or increasing a frequency with which the user of application module 101 is offered awards.

Extrinsic awards can refer to tangible awards and/or independent awards (e.g., awards that hold value outside of system 100). Exemplary extrinsic awards can comprise one or more products/prizes, one or more gift cards, one or more public acknowledgements and/or recognitions, such as, for example, by the organization affiliated with application module 101 and/or by the back end administrator(s) of system 100, and/or money, etc. In some examples, an intrinsic award can be converted to an extrinsic award, such as, for example, where an indication of social status (e.g., a badge) earns a user an extrinsic award (e.g., a free coffee).

Whether the awards comprise intrinsic award(s) and/or extrinsic award(s), to further apply gaming mechanics to the incentive(s), system 100, application module 101, and/or engagement module 102 can be configured so that points and/or system currency can be used by the user of application module 101 to buy the awards and/or redeem the points for the awards through a virtual store. This feeling of choice, in some examples, can further engage the user of application module 101. In other examples, the user of application module 101 can choose the award provided but no point and/or currency redemption is implemented. In still other embodiments, the user of application module 101 can be provided the award without regard to the user's preference in the award.

In some examples, the incentive(s) can be preemptively awarded to the user of application module 101, such as, for example, on the basis that the user may create video content and/or perform user action(s) related to the video content out of a sense of connection to the organization affiliated with application module 101 and/or out of a sense of obligation derived from feelings of maintaining equity with the organization affiliated with application module 101. In further examples, the incentive(s) can be provided as a reward to the user of application module 101 after the user creates video content and/or performs user action(s) relating to the video content. In these latter examples, the allure of the reward can compel the user of application module 101 to create the video content and/or to perform user action(s) related to the video content. In some examples, an individual incentive or multiple incentives can be offered to the user of application module 101. Further, for examples where multiple incentives are offered to the user of application module 101, individual or multiple incentives can be provided for each of the solicitation(s) provided to the user of application module 101.

Accordingly, system 100, application module 101, and/or engagement module 102 can be configured to administrate offering and/or awarding of incentives to the user of application module 101. For example, administrating the offering and/or awarding of the incentive(s) can comprise providing and/or maintaining the internal architecture for the intrinsic awards (e.g., leader boards, inventories of virtual goods, avatars, etc., enhanced application functionality, records of social statuses, calculation engines for assigning social statuses, virtual stores, etc.), providing and/or maintaining tracking systems for assigning and/or awarding points and/or currency to the users of application modules (e.g., application module 101) of system 100, and/or providing and/or maintaining distribution systems for distributing and/or shipping extrinsic goods to users of application modules (e.g., application module 101) of system 100. As needed for these administrative duties and/or any other functionality of engagement module 102, system 100 and/or centralized computer device 105 can comprise any suitable databases at which to store and/or from which to call data for engagement module 102.

Notably, the solicitation(s) provided by engagement module 102 can be actively and/or passively provided to the user of application module 101 to create video content and/or to perform the user action(s) related to the video content. Passive solicitation(s) can refer to solicitation(s) provided after at least some level of user engagement is achieved (e.g., with respect to a particular solicitation) while active solicitation(s) can refer to solicitation(s) provided to induce at least some level of user engagement (e.g., with respect to the particular solicitation). Accordingly, passive solicitation(s) can be considered as rewarding user behavior whereas active solicitation(s) can considered as inducing user behavior.

In many embodiments, engagement module 102 can solicit the user to perform one or more of the user action(s) according to any suitable convention. For example, engagement module 102 can solicit the user to perform one or more of the user action(s) regarding the video content in (a) a predetermined order and/or (b) an optimized order. In these or other embodiments, engagement module 102 can solicit the user to perform the user action(s) regarding the video content (a) individually or (b) multiply at the same time. Prior to describing these conventions in more detail, the following description of the calculation of analytics by engagement module 102, as introduced above, provides some preliminary context.

Engagement module 102 can calculate any suitable analytics based on (a) the behavior of the user of application module 101 and/or (b) the extent to which (i) the user generated video content, (ii) any parameters given for the user generated video content, (iii) the user action(s) regarding the video content, and/or (iv) the incentive(s) provided for creating the video content and/or performing the user action(s) regarding the video content to engage the user and/or people other than the user in a meaningful way with respect to an organization affiliated with the application module. These analytics and any data from which the analytics are calculated can be stored at one or more of the database(s) of engagement module 102, as applicable. As a result of the analytics, engagement module 102 can determine, for example, (a) how the level of user engagement resulting from each of the solicitation(s) responded to by the user of application module 101 compare, (b) which subsequent solicitation(s) will maximize user engagement and/or the engagement of other people based on one or more previous user action(s) performed, (c) which incentive(s) were most likely to maximize the likelihood of the user of application module 101 responding to one or more subsequent solicitation(s), (d) which manner of presenting the incentive(s) was most likely to maximize the likelihood of the user of application module 101 responding to one or more subsequent solicitation(s), (e) whether the user of application module 101 is more likely to respond to subsequent solicitations when provided according to a particular convention, (f) which parameters applied to a solicitation to create video content maximize user engagement, etc.

As qualified above, system 100 can comprise multiple application modules even though system 100 is primarily described with respect to application module 101. Each application module can be affiliated with a different organization. However, in further embodiments, system 100 can comprise multiple groups of application modules, where each group of application modules is affiliated with a different organization. That is, the application module of each group of application modules can be particularly affiliated with and, in many examples, dedicated to a different organization. Thus, in some examples, analytics can be applied across all application modules, across all application modules of a group of like affiliated application modules, and/or across all application modules of like groups of application modules, etc., as desirable. For example, like groups of application modules can comprise groups affiliated with like organizations and/or organizations sharing one or more aspects in common. In a specific example, like groups can comprise groups of application modules affiliated with businesses in the same industry. Further, analytics can be applied based on the users of the application modules (i.e., based on one or more aspects of the users, such as, for example, race, sex, socioeconomic status, religion, education level, location, place of residence, profession, marital status, parental status, etc.).

With this understanding of the analytics calculated by engagement module 102, engagement module 102 can, as applicable, choose whether to provide to the user single or multiple solicitations at a given time in order to maximize the likelihood of user engagement of the user of application module 101 and/or other people. Meanwhile, a predetermined order can refer to an order in which solicitation(s) are provided without factoring analytics and an optimized order can refer to an order in which solicitation(s) are provided that does factor analytics. In many examples, any desirable combination of single solicitation, multiple solicitation, predetermined order solicitation, and/or optimized order solicitation can be implemented. Further, the convention can remain static or can change dynamically, as desired.

In some examples, application module 101 can exploit and/or operate cooperatively with some or all of the video camera software and/or video capture hardware (e.g., video capture device 107, microphone 108, and/or video capture device 111) of user computer device 104 to permit the user of application module 101 to use the video camera software and/or hardware of user computer device 104 (i.e., to create the video content) via application module 101. Further, application module 101 can integrate a control interface of the video camera software to permit the user to use the video camera hardware of user computer device 104, or application module 101 can provide (e.g., via video generation module 109) a separate, application module specific, control interface exploiting and/or operating cooperatively with the video camera hardware of user computer device 104. Accordingly, video generation module 109 can permit the user to create the video content via application module 101. In still other embodiments, the user of application module 101 can create the video content separately from application module 101 and then upload the video content using application module 101. In these or other examples, video generation module 109 can be omitted.

In further examples, application module 101 can exploit and/or operate cooperatively with video editing software of user computer device 104 to permit the user of application module 101 to edit video content (e.g., apply special effects, cut and/or crop content, dub audio, retouch content, etc.) via application module 101. The video editing software can be native to user computer device 104, or after market video editing software downloaded for use at user computer device 104. In many examples, application module 101 can integrate a control interface of the video editing software to permit the user to use the video editing software. In other embodiments, application module 101 can comprise video editing module 110 to permit the user to edit video content via application module 101. Accordingly, video editing module 110 can also provide a control interface by which the user of application module 101 can perform video editing of video content. Both video generation module 109 and video editing module 110 can be configured to communicate with user interface module 103 so that the control interface can be operated via user interface 106. In some embodiments, video editing module 110 can be omitted.

In general, various elements of system 100 (FIG. 1) are described as modules. As described above, each of the modules of system 100 (FIG. 1) is characterized as being configured to perform certain functionality. For illustrative purposes and simplicity, these modules are described as being implemented as computer software. However, these descriptions are not limiting, and in many examples, part or all or one or more of the modules of system 100 (FIG. 1) can be implemented instead as hardware, or in other examples, as a combination of hardware and software, as applicable.

With the architecture and functionality of system 100 established above, in use, application module 101 can be affiliated with an organization (e.g., a business, a government, a charity, etc.) to engage a user of application module 101 and other people in a way meaningful to that organization (i.e., in a way furthering one or more goal(s) and/or objective(s) of that organization). Specifically, application module 101 can comprise a dedicated mobile electronic device application software customized for the affiliated organization by the primary backend operator(s) of system 100. The primary backend operator(s) of system 100 can administrate, support, and/or maintain application module 101 upon the commission of the affiliated organization in order to engage the user of application module 101 and provide increased visibility for the affiliated organization to the user and to other people. In many examples, application module 101 can be made available to the user via the primary backend operator(s) and/or the affiliated organization, such as, for example, by download from a website of the primary backend operator(s) and/or the affiliated organization, and/or through an intermediary such as a software application store (e.g., a digital application distribution platform), such as, for example, the Apple App Store developed and maintained by Apple Inc. of Cupertino, Calif., United States of America.

The affiliated organization can provide the primary backend operator(s) with knowledge of the goal(s) and/or objective(s) that the affiliated organization hopes to achieve and the primary backend operator(s) can customize application module 101, user interface module 103, and/or one or more other elements of system 100 to optimally meet the needs and/or desires of the affiliated organization. In some examples, the affiliated organization can provide the parameters for the video content, the incentive(s), the solicitation(s), and/or the types of analytics calculated. In these or other examples, the affiliated organization can permit the primary backend operator(s) to assign some or all of these details.

Thus, through the creation of video content, the affiliated organization can increase its visibility and engage users of application modules (e.g., application module 101) of system 100 as well as other people by implementing system 100 and/or application module 101.

In some examples, system 100 can be configured such that users of the application module(s) (e.g., application module 101) of system 100 and/or the administrator(s) of engagement module 102 can establish social settings and/or filters (e.g., privacy settings, content filters, etc.) for system 100. In some embodiments, the organization(s) affiliated with the application module(s) can also establish social settings and/or filters. For example, the social settings and/or filters can restrict visibility of video content (e.g., incoming and/or outgoing) created via the application module(s). Further, the social settings and/or filters can restrict visibility of the user's activity, status, and/or other suitable social networking information, as related to system 100. Social settings and/or filters can protect the privacy of the users of the application module(s) (e.g., application module 101) of system 100. Further, social settings and/or filters can protect the image and/or interests of the administrator(s) and/or organization(s) affiliated with the application module(s) of system 100. For example, the administrator(s) and/or organization(s) affiliated with the application module(s) of system 100 may determine not to permit sharing and receiving of certain video content including obscene material. As applied to sharing and receiving video content, the social settings and/or filters can dictate the extent to which video content can be shared and/or received. Social settings and/or filters can also apply to messaging between the users of the application module(s) (e.g., application module 101) of system 100.

In various examples, system 100 can permit the other users of the application module(s) of system 100 to be classified, respectively, according to one or more classifications, by the user of application module 101. Accordingly, the user of application module 101 can then restrict visibility of video content, user status, and/or user activity, etc. to certain classifications. Further, the user of application module 101 can also restrict the video content, other user status, and/or other user activity, etc. visible to the user of application module 101, according to the same or other classifications. In further examples, system 100 can permit the user of application module 101 to adjust the level of stimuli (e.g., video content) received from one or more of the other users of the application module(s) of system 100.

In operation, in many embodiments, the user(s) of the application module(s) (e.g., application module 101) of system 100 can adjust the social settings and/or filters, as desirable, via the graphical user interface provided by user interface module 103. Meanwhile, the administrator(s) and/or organization(s) affiliated with the application module(s) of system 100 can adjust social settings and/or filters of system 100 on the back end via engagement module 102.

As indicated previously, in many embodiments, when comprising multiple application modules, the application modules of system 100 (e.g., application module 101) can be configured to permit communication, and in some embodiments messaging, between the user(s) of the application module(s), established social settings and/or filters permitting. Additionally or alternatively to communicating video content, the user(s) can communicate written and/or audible messages, user locations, and/or pictographs (e.g., emoticons, stickers, etc.), etc. to each other. In some examples, the application modules of system 100 can be configured to communicate with each other even in embodiments when system 100 is not also configured to provide gamification functionality, social settings and/or filters, gesture-based control, social network searching of the user of application module 101 and/or the users of the other application module(s) of system 100, and/or other functionality described herein.

In some embodiments, system 100 can be implemented with respect to photographic content (e.g., still imagery) in addition to, or as opposed to, video content. To the extent system 100 is implemented with respect to photographic content, system 100 can be implemented with respect to the photographic content in a similar or identical manner to the manner in which system 100 is implemented with respect to video content. Further in these embodiments, video capture device 107 and/or video capture device 111 can also be configured to capture photographic content. In other embodiments, system 100 can be expressly devoid of the capability to be implemented with photographic content.

In practical application, system 100 can permit the user of application module 101 to create and share video content in the footprint(s) (e.g., retail footprint(s)) of the organization(s) affiliated with those application module(s), extending the brand relationship naturally. The more the user of application module 101 creates video content and/or performs user action(s) related to the video content, engagement module 102 can offer more and/or better incentives to the user to encourage the user of application module 101 to create the video content and/or to perform the user action(s) related to the video content. The incentive(s) can be pushed immediately while the user is in a retail store for savings/deals upon check-out. Further, when user computer device 104 is implemented as a head mountable wearable user computer device, the hands of the user of application module 101 can be freed, making the retail shopping experience completely natural.

Meanwhile, by applying spatial constraints (e.g., geo-fencing) and/or temporal constraints (e.g., time fencing) to the user, system 100 and/or engagement module 102 can extend brand relationships even further. For example, system 100 and/or engagement module 102 can operate to encourage engagement with a user when the user is within a geographic perimeter, and further, can function to keep that user engaged within the geographic perimeter for as long as possible. Similarly, system 100 and/or engagement module 102 can operate to encourage engagement with a user when the user is within a particular time period. For example, the time period could be a window of an event, a window of time including the event, or a recurring date and/or time. In general, the more frequently and/or longer the user is engaged, the more likely a casual user may become a repeat user.

In a specific example, the user of application module 101 can walk into a store for the organization affiliated with application module 101 and can create video content and can upload the video content to a social network while in the store. Engagement module 102 can provide the user of application module 101 with a coupon, code, badge, or other suitable award for each video content created and/or each user action related to the video content that the user of application module 101 performs while at the store.

Further, system 100 can permit the user of application module 101 to create photographic and/or video content at an event (e.g., a concert, a sports game) and/or at a location (e.g., a retail store, a theater, a booth, etc.) of the organization affiliated with application module 101. The photographic content and/or video content can be uploaded (e.g., instantly) to social networks or directly to brand campaigns of the organization affiliated with application module 101 for a chance to win award(s). For example, the photographic and/or video content could be uploaded to the Facebook social network page and/or Twitter account of the organization affiliated with application module 101.

For example, engagement module 102 can solicit the user of application module 101 to create video content with the parameter that the video content include an “opening act” of a concert and that the video content be created at the concert, such as, for example, when the organization affiliated with application module 101 is the band performing the concert. In another example, engagement module 102 can solicit the user of application module 101 to create photographic content with the parameter that the photographic content include a logo or other image and that the photographic content be created in a retail store, such as, for example, when the organization affiliated with application module 101 owns and/or operates the retail store. Geo-tags applied to the photographic and/or video content can confirm the authenticity of the location at which the photographic and/or video content was created. Further, engagement module 102 can offer awards to the user of application module 101 for creating and/or sharing the photographic and/or video content.

Further, system 100 can permit an organization affiliated with application module 101 to associate fans of the organization with each other, upon approval by the fans, such as, for example, for purposes of fan association and/or crowd sourcing. For example, the user of application module 101 can opt-in to receive alerts provided via engagement module 102 when other users of the application module(s) of system 100 are nearby or have taken advantage of offers of that organization.

For example, under instruction from engagement module 102, user interface module 103 can display an alert (e.g., in real-time) at a real-time electronic display of user interface 106 of user computer device 104, such as, for example, when user computer device 104 comprises a head mountable wearable user computer device. The alert can notify the user of application module 101 that another user of another application module of system 100 is nearby, has participated in a campaign of the organization affiliated with application module 101, and/or has taken advantage of an offer that might interest the user of application module 101. If the user of application module 101 desires to respond to the alert, the user can respond (e.g., in real-time) by creating photographic and/or video content, by checking in to a social network, etc. Accordingly, engagement module 102 can verify participation and/or location. Meanwhile, these alerts can be subject to the social settings and/or filters established for system 100. In these examples, the alerts could be used to simply associate one fan with another or as a crowd sourcing tool (e.g., providing fifteen people have claimed an offer, and if five more people claim the offer, everyone gets a particular award).

Further, system 100 can permit an organization affiliated with application module 101 to offer exclusive content, information, and awards to fans of the organization. When the user interface 106 of user computer device 104 comprises a real-time electronic display, the affiliated organization can integrate product information onto store shelves (e.g., more sizes, colors, etc.) viewable and orderable via the Internet, showcase product back stories (e.g., creation and/or manufacturing videos, etc.), and/or offer personal shopping assistance based on what the user of application module 101 puts within his or her field of vision.

For example, assuming user computer device 104 comprises a head mountable wearable user computer device and user interface 106 comprises a real-time electronic display, a user of application module 101 could walk into a retail store owned and/or operated by an organization affiliated with application module 101. An employee of the retail store could let the user know the retail store is configured for use with the head mountable wearable user computer device and real-time electronic display. When the user views a display of sweaters, engagement module 102 can instruct user interface module 103 to display an alert at the real-time electronic display notifying the user that more information on the sweaters is available. Selecting to receive the additional information, the user can learn about other products sold by the retail store that would complement the sweaters (e.g., matching socks, a scarf, etc.), and/or the user can learn that a color of the sweaters not available at the store can be ordered immediately via the Internet. Next, selecting to receive additional information on belts in the store, the user can access video content showing the belt manufacturer in action. The user can share the video content after viewing the video content and receive an award from engagement module 102 for sharing the video content and/or for purchasing a belt. Before leaving the store, the user can create photographic content of the employee's name tag, review his or her experience, and thanking the organization for its supplemental help, earning additional awards from engagement module 102 in the process.

Further, system 100 can be implemented with virtual signage, such as, for example a virtual billboard. For example, assuming again that user computer device 104 comprises a head mountable wearable user computer device and user interface 106 comprises a real-time electronic display, the user of application module 101 can approach a gate for a bicycle race. A virtual billboard can be located twenty feet over the gate, and engagement module 102 can be programmed with coordinates of the virtual billboard. Upon approaching the gate, engagement module 102 can instruct user interface module 103 to superimpose over the gate on the real-time electronic display an animated arrow pointing up to the virtual billboard. When the user of application module 101 looks up, video content at the virtual billboard comes into view on the real-time electronic display, where it shows and tells the user about a promotion on merchandise of an organization affiliated with application module 101 available at a stall of the organization. Then, engagement module 102 can notify user interface module 103 to display an alert at the real-time electronic display inquiring if the user of application module 101 desires to see additional information about the merchandise. Using optical recognition, application module 101 and/or user interface module 103 can track the movement of the user's finger up to the alert, which application module 101 and/or user interface module 103 can interpret as confirmation that the user is requesting the information. In cooperation with engagement module 102, user interface module 103 can superimpose a line on the real-time electronic display leading the user to the stall of the organization. Upon reaching the stall, engagement module 102 can solicit the user to purchase merchandise from the stall and offer an award for making the purchase. Engagement module 102 can validate the purchase by tracking where the user is looking and located.

Although the foregoing example is described regarding virtual signage, these concepts could apply similarly to substantially any media content for which engagement module 102 could proffer the user to receive additional information. Upon receiving confirmation, engagement module 102 can superimpose any application information, directions, etc. that could apply to the particular media content. Moreover, these concepts could apply generally to implementing system 100 in a scavenger hunt format, directing the user to move from location to location.

Further, system 100 can permit an organization affiliated with application module 101 to control the in-store experience of the user of application module 101. For example, assuming again that user computer device 104 comprises a head mountable wearable user computer device and user interface 106 comprises a real-time electronic display, as the user makes his or her way through a retail store of the organization, engagement module 102 can cooperate with user interface module 103 to provide arrows and instructions guiding the user through the in-store experience. For one or more of the actions, engagement module 102 can provide awards and solicit additional user actions.

Also, system 100 can automate procedures that otherwise might occur manually. For example, system 100 can automate a vehicle test drive so that a salesman need not accompany the test driver during the test drive. Depending on how thorough of a test drive the user of application module 101 performs, engagement module 102 can provide increasing awards to encourage the user. In particular, assuming again that user computer device 104 comprises a head mountable wearable user computer device and user interface 106 comprises a real-time electronic display, engagement module 102 can cooperate with user interface module 103 to provide turn-by-turn directions while implementing created recorded video content of the vehicular progress of the user of application module 101. Engagement module 102 can award the user for taking actions like using the radio, cruise control, taking a particular route, making a turn at a particular speed, slamming on the brakes to check stopping distance, etc. For example, the awards could be savings off the price of the vehicle.

Further still, system 100 can permit an organization affiliated with application module 101 to integrate products with consumer lifestyles. For example, assuming again that user computer device 104 comprises a head mountable wearable user computer device and user interface 106 comprises a real-time electronic display, and assuming further that the user of application module 101 is a runner, engagement module 102 can cooperate with user interface module 103 to solicit the user of application module 101 to complete certain tasks during a run. Exemplary tasks could include reaching the top of a hill, reaching a distance marker, sprinting the final 400 meters, etc. Meanwhile, engagement module 102 can receive streaming and/or recorded video content of the run from user computer device 104, which can be provided to an organization affiliated with application module 101, and the user of application module 101 is provided with added enjoyment during the run. In turn, the relationship between the organization and the user of application module 101 can be strengthened. As the user completes tasks, engagement module 102 can offer awards to the user, such as, for example, discounts for products for sale by the organization.

In yet another practical example, system 100 can be implemented to encourage premium purchases and/or promote future purchases. For example, in the context of an air traveler, system can be implemented to encourage premium seating purchases and/or purchases during a flight. Accordingly, the experience of the user of application module 101 can be more personalized and in depth.

Specifically, assuming again that user computer device 104 comprises a head mountable wearable user computer device and user interface 106 comprises a real-time electronic display, and assuming further that the user of application module 101 is on a flight offering a wireless internet connection to premium passengers, the user of application module 101 can engage in any suitable Internet activity via user computer device 104. Meanwhile, engagement module 102 can cooperate with user interface module 103 to provide (e.g., in real-time) location, air speed, in-flight menu options, destination information, and/or any other suitable aircraft and/or travel information at the real-time electronic display. Further, application module 101, engagement module 102, and/or user interface module 103 could provide streaming video content at the real-time electronic display in the form of a movie or television show. Actions taken by the user of application module 101 can be awarded by engagement module 102, encouraging loyalty to the organization affiliated with application module 101, which in these examples could be the airline. Further still, engagement module 102 can solicit certain actions (e.g., checking destination weather, checking into a rental car service, having a drink at an airport bar during a layover, etc.) tied with awards from engagement module 102 to promote behavior by the user of application module 101 prior to landing.

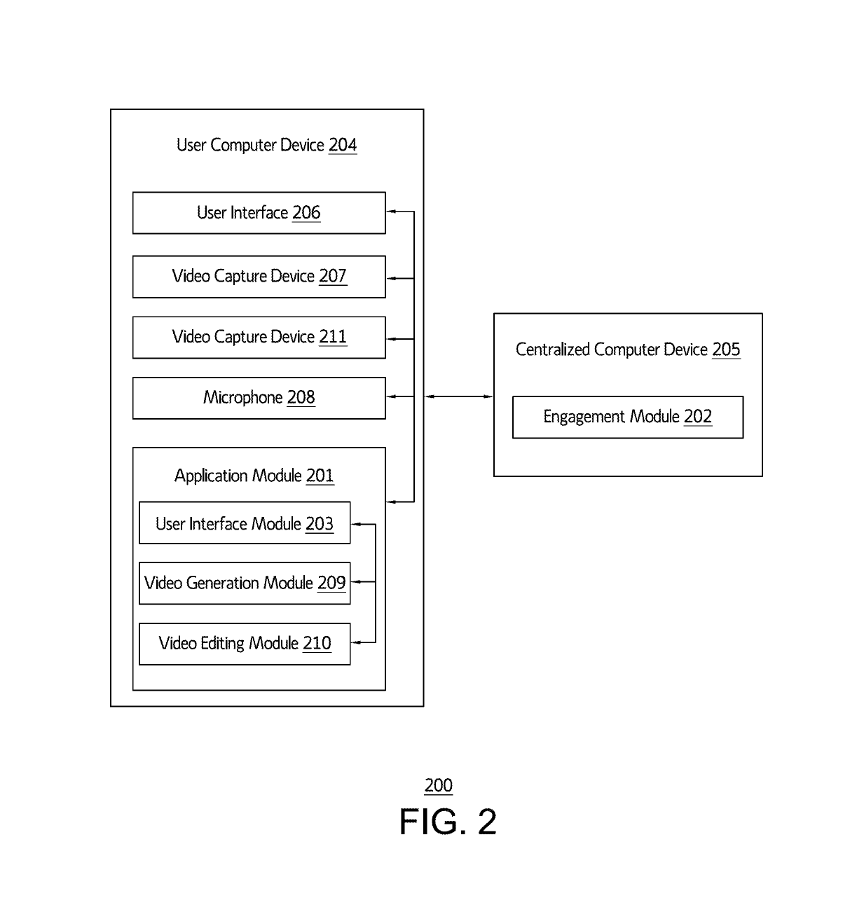

Turning ahead now in the drawings, FIG. 2 illustrates system 200, according to an embodiment. System 200 is also merely exemplary and is not limited to the embodiments presented herein. System 200 can be employed in many different embodiments or examples not specifically depicted or described herein. System 200 can be similar to system 100 (FIG. 1).

System 200 comprises engagement module 202 and can comprise application module 201. In contrast, in FIG. 1, system 100 comprises application module 101 and can comprise engagement module 102. Application module 201 comprises user interface module 203. Meanwhile, in some embodiments, system 200 can comprise user computer device 204 and/or centralized computer device 205. Still, in other embodiments, user computer device 204 can be omitted. User computer device 204 comprises user interface 206. In some embodiments, user computer device 204 can comprise video capture device 207, microphone 208, and/or video capture device 211. In other embodiments, video capture device 211 can be omitted. Application module 201 can comprise video generation module 209 and/or video editing module 210. In other embodiments, video generation module 209 and/or video editing module 210 can be omitted.

Application module 201, engagement module 202, user interface module 203, user computer device 204, centralized computer device 205, user interface 206, video capture device 207, microphone 208, video generation module 209, video editing module 210, and/or video capture device 211 can be similar or identical to application module 101 (FIG. 1), engagement module 102 (FIG. 1), user interface module 103 (FIG. 1), user computer device 104 (FIG. 1), centralized computer device 105 (FIG. 1), user interface 106 (FIG. 1), video capture device 107 (FIG. 1), microphone 108 (FIG. 1), video generation module 109 (FIG. 1), video editing module 110 (FIG. 1), and/or video capture device 111 (FIG. 1), respectively, as described above.

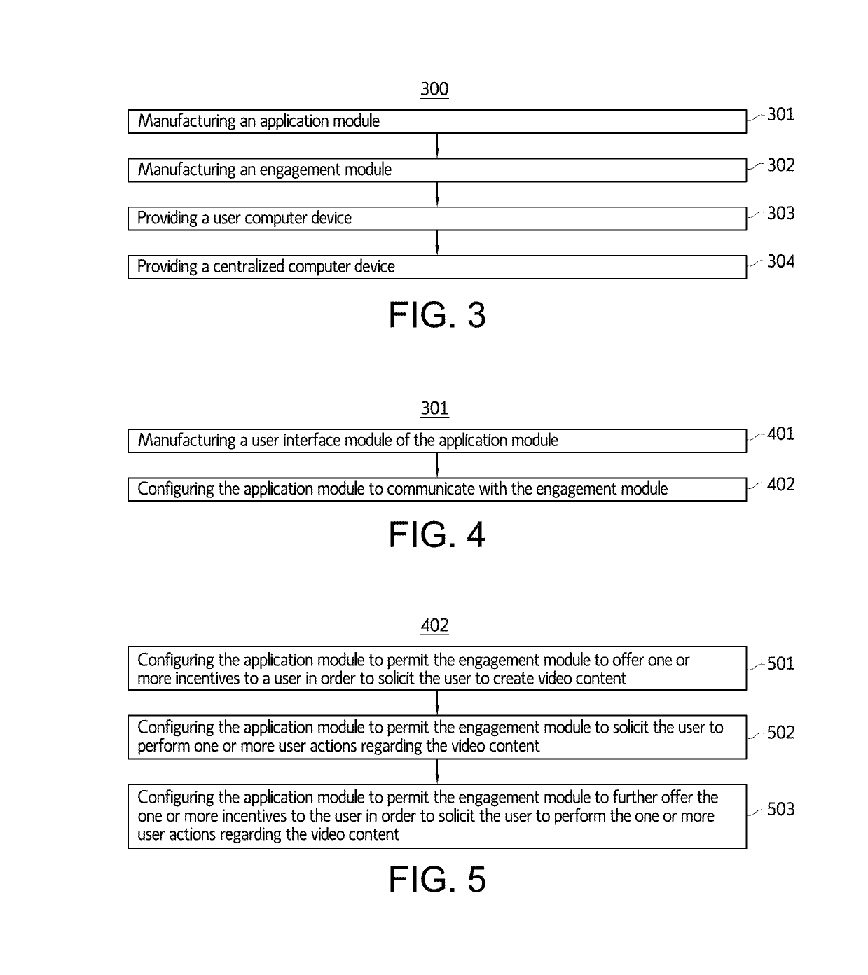

Turning ahead again in the drawings, FIG. 3 illustrates a flow chart for an embodiment of method 300 of manufacturing a system. The system can be similar or identical to system 100 (FIG. 1) and/or can be similar to system 200 (FIG. 2). Method 300 is merely exemplary and is not limited to the embodiments presented herein. Method 300 can be employed in many different embodiments or examples not specifically depicted or described herein. In some embodiments, the activities, the procedures, and/or the processes of method 300 can be performed in the order presented. In other embodiments, the activities, the procedures, and/or the processes of method 300 can be performed in any other suitable order. In still other embodiments, one or more of the activities, the procedures, and/or the processes in method 300 can be combined or skipped.

Method 300 can comprise activity 301 of manufacturing an application module. The application module can be similar or identical to application module 101 (FIG. 1) and/or application module 201 (FIG. 2). As an example, the manufacturing of activity 301 can include writing computer source code and/or copying computer source code and/or object code. Further, performing one or more of the activities of which activity 301 can be comprised (e.g., activities 401, 402, 501, 502, and/or 503) also can include writing computer source code and/or copying computer source code and/or object code. FIG. 4 illustrates a flow chart for an exemplary embodiment of activity 301, according to the embodiment of FIG. 3.

Activity 301 can comprise activity 401 of manufacturing a user interface module of the application module. The user interface module can be similar or identical to user interface module 103 (FIG. 1) and/or user interface module 203 (FIG. 2).

Activity 301 also can comprise activity 402 of configuring the application module to communicate with an engagement module. The engagement module can be similar or identical to engagement module 102 (FIG. 1) and/or engagement module 202 (FIG. 2). FIG. 5 illustrates a flow chart for an exemplary embodiment of activity 402, according to the embodiment of FIG. 3.

Activity 402 can comprise activity 501 of configuring the application module to permit the engagement module to offer one or more incentives to a user in order to solicit the user to create video content. The incentive(s) can be similar or identical to the incentive(s) described above with respect to system 100 (FIG. 1) and/or system 200 (FIG. 2).

Activity 402 also can comprise activity 502 of configuring the application module to permit the engagement module to solicit via the application module the user to perform one or more user actions regarding the video content. The user action(s) regarding the video content can be similar or identical to the user action(s) regarding the video content described above with respect to system 100 (FIG. 1) and/or system 200 (FIG. 2).

Activity 402 can further comprise activity 503 of configuring the application module to permit the engagement module to further offer the one or more incentives to the user in order to solicit via the application module the user to perform the one or more user actions regarding the video content. In some examples, activity 502 and/or activity 503 can be omitted.

Returning now to FIG. 3, method 300 also can comprise activity 302 of manufacturing the engagement module. As an example, the manufacturing of activity 302 can include writing computer source code and/or copying computer source code and/or object code. In some embodiments, activity 302 can be omitted. In other embodiments, activity 302 can be performed during or before activity 301, and/or before activity 402.

Method 300 can further comprise activity 303 of providing a user computer device. The user computer device can be similar or identical to user computer device 104 (FIG. 1) and/or user computer device 204 (FIG. 2). In some embodiments, activity 303 can be omitted.

In some embodiments, performing activity 303 can comprise providing a mobile electronic device. In these or other embodiments, performing activity 303 can comprise providing a wearable user computer device, such as, for example, a head mountable user computer device and/or a limb mountable user computer device. The mobile electronic device can be similar or identical to the mobile electronic device described above with respect to system 100 (FIG. 1) and/or system 200 (FIG. 2). Further, the wearable user computer device can be similar or identical to the wearable user computer device described above with respect to system 100 (FIG. 1) and/or system 200 (FIG. 2).

Method 300 also can comprise activity 304 of providing a centralized computer device. The centralized computer device can be similar or identical to centralized computer device 105 (FIG. 1) and/or centralized computer device 205 (FIG. 2). In some embodiments, activity 304 can be omitted.

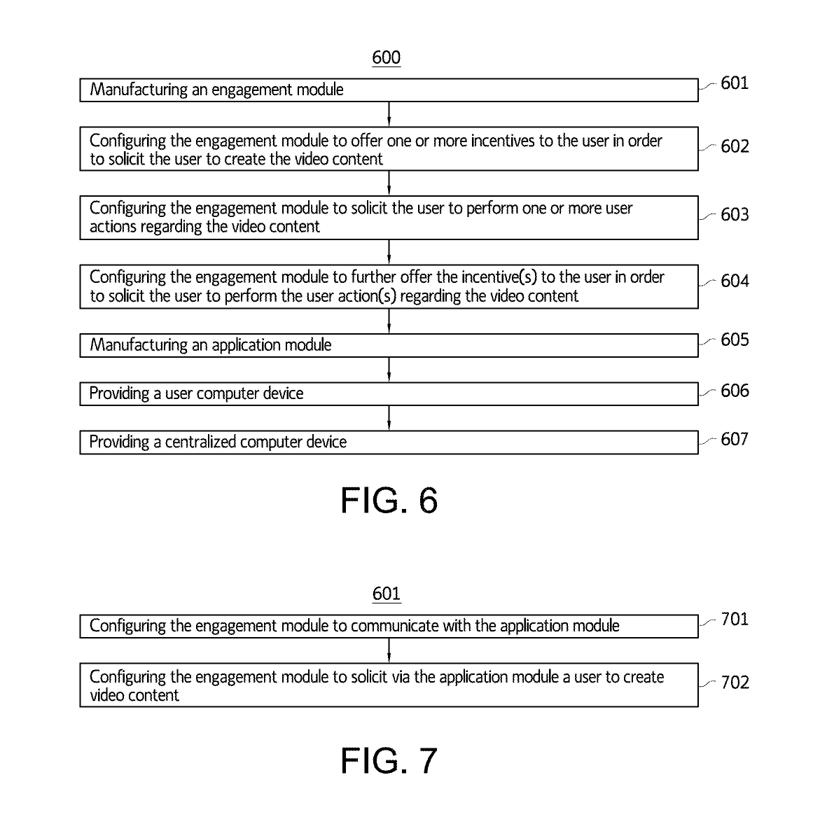

Turning ahead again in the drawings, FIG. 6 illustrates a flow chart for an embodiment of method 600 of manufacturing a system. The system can be similar to system 100 (FIG. 1) and/or can be similar or identical to system 200 (FIG. 2). Method 600 is merely exemplary and is not limited to the embodiments presented herein. Method 600 can be employed in many different embodiments or examples not specifically depicted or described herein. In some embodiments, the activities, the procedures, and/or the processes of method 600 can be performed in the order presented. In other embodiments, the activities, the procedures, and/or the processes of method 600 can be performed in any other suitable order. In still other embodiments, one or more of the activities, the procedures, and/or the processes in method 600 can be combined or skipped.

Method 600 can comprise activity 601 of manufacturing an engagement module. The engagement module can be similar or identical to engagement module 102 (FIG. 1) and/or engagement module 202 (FIG. 2). As an example, the manufacturing of activity 601 can include writing computer source code and/or copying computer source code and/or object code. Further, performing one or more of the activities of which activity 601 can be comprised (e.g., activities 701, 702, 602, 603, and/or 604) also can include writing computer source code and/or copying computer source code and/or object code. FIG. 7 illustrates a flow chart for an exemplary embodiment of activity 601, according to the embodiment of FIG. 6.

Activity 601 can comprise activity 701 of configuring the engagement module to communicate with an application module. The application module can be similar or identical to application module 101 (FIG. 1) and/or application module 201 (FIG. 2).

Activity 601 also can comprise activity 702 of configuring the engagement module to solicit via the application module a user to create video content. The video content can be similar or identical to the video content described above with respect to system 100 (FIG. 1) and/or system 200 (FIG. 2).

Referring back to FIG. 6, method 600 can further comprise activity 602 of configuring the engagement module to offer one or more incentives to the user in order to solicit via the application module the user to create the video content. The incentive(s) can be similar or identical to the incentive(s) described above with respect to system 100 (FIG. 1) and/or system 200 (FIG. 2).

Method 600 also can comprise activity 603 of configuring the engagement module to solicit via the application module the user to perform one or more user actions regarding the video content. The user action(s) regarding the video content can be similar or identical to the user action(s) regarding the video content described above with respect to system 100 (FIG. 1) and/or system 200 (FIG. 2).

Method 600 can still further comprise activity 604 of configuring the engagement module to further offer the incentive(s) to the user in order to solicit via the application module the user to perform the user action(s) regarding the video content. In some embodiments, activity 603 and/or activity 604 can be omitted. In further embodiments, one or more of activities 602-604 can be performed as part of activity 601.

Method 600 can comprise activity 605 of manufacturing the application module. As an example, the manufacturing of activity 605 can include writing computer source code and/or copying computer source code and/or object code. In some embodiments, activity 605 can be omitted. In other embodiments, activity 605 can occur before or during activity 601 and/or before activity 701.

Method 600 can comprise activity 606 of providing a user computer device. The user computer device can be similar or identical to user computer device 104 (FIG. 1) and/or user computer device 204 (FIG. 2). In some embodiments, activity 606 can be omitted.

In some embodiments, performing activity 606 can comprise providing a mobile electronic device. In these or other embodiments, performing activity 606 can comprise providing a wearable user computer device, such as, for example, a head mountable user computer device and/or a limb mountable user computer device. The mobile electronic device can be similar or identical to the mobile electronic device described above with respect to system 100 (FIG. 1) and/or system 200 (FIG. 2). Further, the wearable user computer device can be similar or identical to the wearable user computer device described above with respect to system 100 (FIG. 1) and/or system 200 (FIG. 2).

Method 600 can comprise activity 607 of providing a centralized computer device. The user computer device can be similar or identical to centralized computer device 105 (FIG. 1) and/or centralized computer device 205 (FIG. 2). In some embodiments, activity 607 can be omitted.

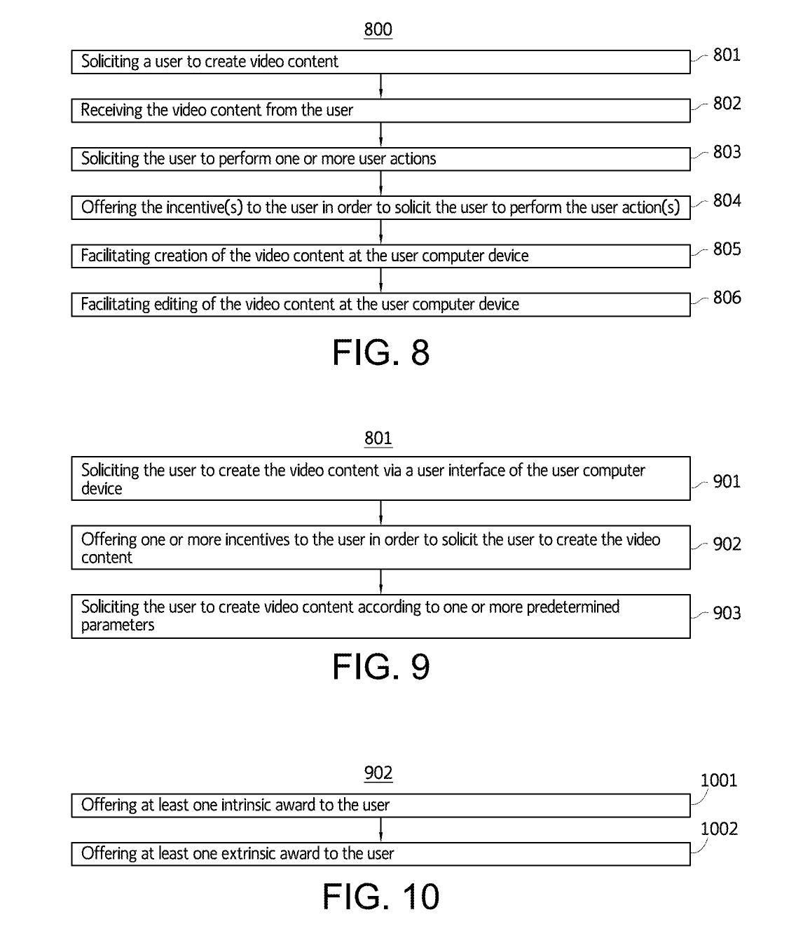

Skipping ahead in the drawings, FIG. 8 illustrates a flow chart for an embodiment of method 800. Method 800 is merely exemplary and is not limited to the embodiments presented herein. Method 800 can be employed in many different embodiments or examples not specifically depicted or described herein. In some embodiments, the activities, the procedures, and/or the processes of method 800 can be performed in the order presented. In other embodiments, the activities, the procedures, and/or the processes of method 800 can be performed in any other suitable order. In still other embodiments, one or more of the activities, the procedures, and/or the processes in method 800 can be combined or skipped. Method 800 can be implemented via execution of computer instructions configured to run at one or more user processing modules of a user computer device and configured to be stored in one or more non-transitory user memory storage modules of the user computer device. The user computer device can be similar or identical to user computer device 104 (FIG. 1) and/or user computer device 204 (FIG. 2). In other embodiments, method 800 can be implemented via execution of computer instructions configured to run at one or more user processing modules of a centralized computer device and configured to be stored in one or more non-transitory user memory storage modules of the centralized computer device. The centralized computer device can be similar or identical to centralized computer device 105 (FIG. 1) and/or centralized computer device 205 (FIG. 2).

Method 800 can comprise activity 801 of soliciting a user to create video content. The video content can be similar or identical to the video content described above with respect to system 100 (FIG. 1) and/or system 200 (FIG. 2). In some examples, activity 801 can comprise soliciting the user to create recorded video content and/or streaming video content. Recorded video content and/or streaming video content can be similar or identical to recorded video content and/or streaming video content, respectively, as described above with respect to system 100 (FIG. 1) and/or system 200 (FIG. 2). FIG. 9 illustrates a flow chart for an exemplary embodiment of activity 801, according to the embodiment of FIG. 8.

Activity 801 can comprise activity 901 of soliciting the user to create the video content via a user interface of the user computer device. The user interface can be similar or identical to user interface 106 (FIG. 1) and/or user interface 206 (FIG. 2). In some embodiments, activity 901 can be omitted. For example, activity 901 can comprise soliciting the user to create the video content via the user interface through a graphical user interface, an electronic mail, a text message, instant message, and/or an automated telephone call provided at the user interface.

Activity 801 also can comprise activity 902 of offering one or more incentives to the user in order to solicit the user to create the video content. The incentive(s) can be similar or identical to the incentive(s) described above with respect to system 100 (FIG. 1) and/or system 200 (FIG. 2). FIG. 10 illustrates a flow chart for an exemplary embodiment of activity 902, according to the embodiment of FIG. 8.

Activity 902 can comprise activity 1001 of offering at least one intrinsic award to the user. The intrinsic award(s) can be similar or identical to the intrinsic award(s) of system 100 (FIG. 1) and/or system 200 (FIG. 2).

Activity 902 also can comprise activity 1002 of offering at least one extrinsic award to the user. The extrinsic award(s) can be similar or identical to the extrinsic award(s) of system 100 (FIG. 1) and/or system 200 (FIG. 2). In some embodiments, one of activity 1001 or activity 1002 can be omitted.

Referring back to FIG. 9, activity 801 can comprise activity 903 of soliciting the user to create video content according to one or more predetermined parameters. The parameter(s) can be similar or identical to the parameter(s) associated with creating video content as described above with respect to system 100 (FIG. 1) and/or system 200 (FIG. 2). In some embodiments, activity 903 can be omitted.

Returning now to FIG. 8, method 800 can further comprise activity 802 of receiving the video content from the user. In many examples, performing activity 802 can comprise receiving the video content from the user via the user computer device. In these or other examples, performing activity 802 can comprise receiving the video content from the user at the user computer device. In further examples, activity 802 can comprise receiving the video content from the user at the centralized computer device, such as, for example, from the user computer device. In some embodiments, activity 801 and activity 802 can be performed approximately simultaneously. Meanwhile, in other embodiments, activity 801 and/or activity 802 can be omitted.

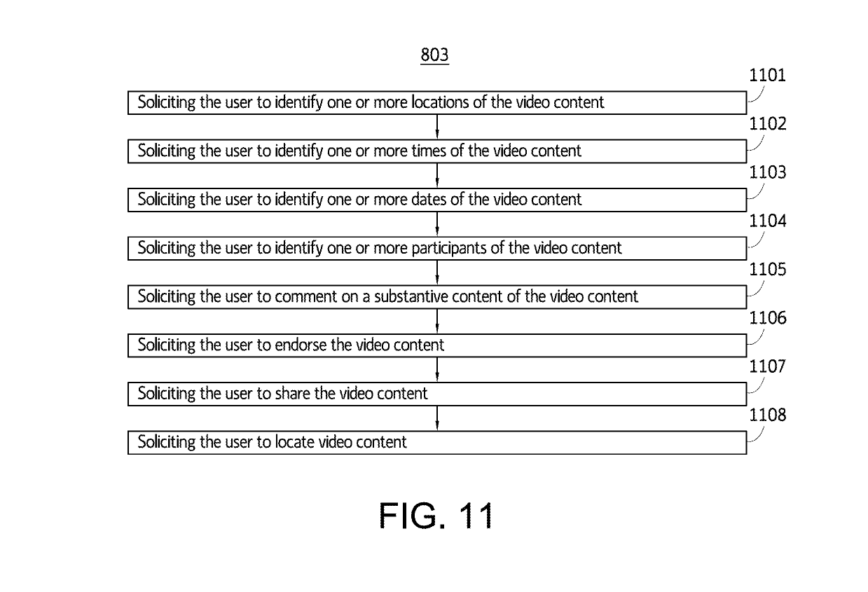

Continuing with FIG. 8, method 800 also can comprise activity 803 of soliciting the user to perform one or more user actions. The user action(s) can be similar or identical to the user action(s) described above with respect to system 100 (FIG. 1) and/or system 200 (FIG. 2). In many examples, activity 803 can comprise soliciting the user to perform one or more user actions regarding video content. In many examples, the video content can comprise video content created by the user in response to activity 801. In various examples, activity 803 can be performed after activity 801. FIG. 11 illustrates a flow chart for an exemplary embodiment of activity 803, according to the embodiment of FIG. 8.

For example, activity 803 can comprise activity 1101 of soliciting the user to identify one or more locations of the video content; activity 803 can comprise activity 1102 of soliciting the user to identify one or more times of the video content; activity 803 can comprise activity 1103 of soliciting the user to identify one or more dates of the video content; activity 803 can comprise activity 1104 of soliciting the user to identify one or more participants of the video content; activity 803 can comprise activity 1105 of soliciting the user to summarize a substantive content of the video content; activity 803 can comprise activity 1106 of soliciting the user to endorse the video content; activity 803 can comprise activity 1107 of soliciting the user to share the video content; and/or activity 803 can comprise activity 1108 of soliciting the user to locate video content (e.g., similar video content). The sequence of activities 1101-1108 can be varied.

In many examples, performing activity 803 can comprise soliciting the user to perform multiple of the user action(s) according to one of a predetermined or an optimized order. The predetermined and/or optimized order can be similar or identical to the predetermined and/or optimized order, respectively, described above with respect to system 100 (FIG. 1) and/or system 200 (FIG. 2).

In many examples, returning to FIG. 8, method 800 also can comprise activity 804 of offering incentive(s) to the user in order to solicit the user to perform the user action(s). In some embodiments, activity 803 and activity 804 can be performed approximately simultaneously. In many examples, activity 801, activity 802, activity 803, and/or activity 804 can be repeated one or more times. In further examples, activity 803 and/or activity 804 can be omitted.

In some examples, method 800 can further comprise activity 805 of facilitating creation of video content at the user computer device. In many examples, the video content can comprise video content created by the user in response to activity 801. In some embodiments, activity 805 can be omitted.

In still further examples, method 800 can comprise activity 806 of facilitating editing of video content at the user computer device. In many examples, the video content can comprise video content created by the user in response to activity 801. In some embodiments, activity 806 can be omitted.

Although one or more of activities 801-806 can be omitted, method 800 comprises at least one of activities 801-806.

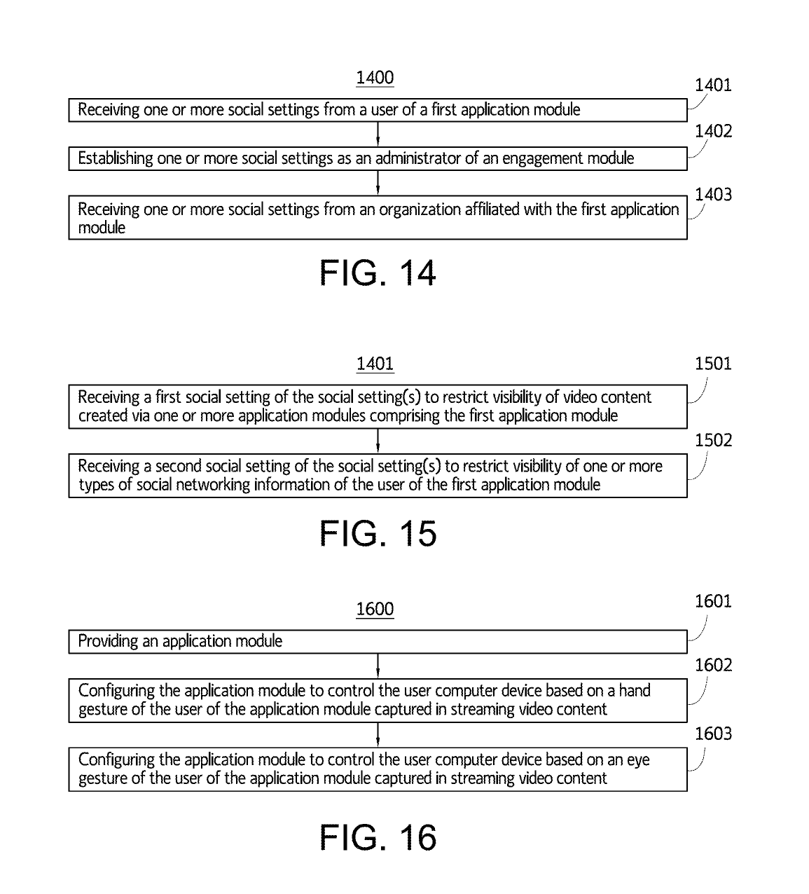

Skipping ahead again in the drawings, FIG. 14 illustrates a flow chart for an embodiment of method 1400. Method 1400 is merely exemplary and is not limited to the embodiments presented herein. Method 1400 can be employed in many different embodiments or examples not specifically depicted or described herein. In some embodiments, the activities, the procedures, and/or the processes of method 1400 can be performed in the order presented. In other embodiments, the activities, the procedures, and/or the processes of method 1400 can be performed in any other suitable order. In still other embodiments, one or more of the activities, the procedures, and/or the processes in method 1400 can be combined or skipped. Method 1400 can be implemented via execution of computer instructions configured to run at one or more user processing modules of a user computer device and configured to be stored in one or more non-transitory user memory storage modules of the user computer device. The user computer device can be similar or identical to user computer device 104 (FIG. 1) and/or user computer device 204 (FIG. 2). In other embodiments, method 1400 can be implemented via execution of computer instructions configured to run at one or more user processing modules of a centralized computer device and configured to be stored in one or more non-transitory user memory storage modules of the centralized computer device. The centralized computer device can be similar or identical to centralized computer device 105 (FIG. 1) and/or centralized computer device 205 (FIG. 2). In some embodiments, method 1400 (and/or one of the activities of method 1400) can be performed as part of method 800 (FIG. 8).

Method 1400 can comprise activity 1401 of receiving one or more social settings from a user of a first application module. The social settings can be similar or identical to the social settings described above with respect to system 100 (FIG. 1) and/or system 200 (FIG. 2), and the first application module can be similar or identical to the application module 101 (FIG. 1) and/or application module 201 (FIG. 2). FIG. 15 illustrates a flow chart for an exemplary embodiment of activity 1401, according to the embodiment of FIG. 14.

Activity 1401 can comprise activity 1501 of receiving a first social setting of the social setting(s) to restrict visibility of video content created via one or more application modules comprising the first application module. The application module(s) can each be similar or identical to the first application module.

Activity 1401 can comprise activity 1502 of receiving a second social setting of the social setting(s) to restrict visibility of one or more types of social networking information of the user of the first application module. The types of social networking information can be similar or identical to the types of social networking information described above with respect to system 100 (FIG. 1) and/or system 200 (FIG. 2). In some embodiments, activity 1501 and/or activity 1502 can be omitted.

Method 1400 can comprise activity 1402 of establishing one or more social settings as an administrator of an engagement module. The engagement module can be similar or identical to engagement module 102 (FIG. 1) and/or engagement module 202 (FIG. 2). Further, the administrator can be similar or identical to the administrator as described above with respect to system 100 (FIG. 1) and/or system 200 (FIG. 2). In some embodiments, activity 1402 can be omitted.

Method 1400 can comprise activity 1403 of receiving one or more social settings from an organization affiliated with the first application module. The organization affiliated with the first application module can be similar or identical to the organization affiliated with application module 101 (FIG. 1) as described above with respect to system 100 (FIG. 1) and/or the organization affiliated with application module 201 (FIG. 2) as described above with respect to system 200 (FIG. 2). In some embodiments, activity 1403 can be omitted.

Although one or more of activities 1401-1403 can be omitted, method 1400 comprises at least one of activities 1401-1403.

Skipping further ahead in the drawings, FIG. 16 illustrates a flow chart for an embodiment of method 1600. Method 1600 is merely exemplary and is not limited to the embodiments presented herein. Method 1600 can be employed in many different embodiments or examples not specifically depicted or described herein. In some embodiments, the activities, the procedures, and/or the processes of method 1600 can be performed in the order presented. In other embodiments, the activities, the procedures, and/or the processes of method 1600 can be performed in any other suitable order. In still other embodiments, one or more of the activities, the procedures, and/or the processes in method 1600 can be combined or skipped. Method 1600 can be implemented via execution of computer instructions configured to run at one or more user processing modules of a user computer device and configured to be stored in one or more non-transitory user memory storage modules of the user computer device. The user computer device can be similar or identical to user computer device 104 (FIG. 1) and/or user computer device 204 (FIG. 2). In other embodiments, method 1600 can be implemented via execution of computer instructions configured to run at one or more user processing modules of a centralized computer device and configured to be stored in one or more non-transitory user memory storage modules of the centralized computer device. The centralized computer device can be similar or identical to centralized computer device 105 (FIG. 1) and/or centralized computer device 205 (FIG. 2).

Method 1600 can comprise providing an application module. The application module can be similar or identical to application module 101 (FIG. 1) and/or application module 201 (FIG. 2).

Method 1600 can comprise activity 1602 of configuring the application module to control the user computer device based on a hand gesture of the user of the application module captured in streaming video content. The hand gesture can be similar or identical to one of the hand gestures described above with respect to system 100 (FIG. 1) and/or system 200 (FIG. 2). Further, the streaming video content can be similar or identical to the streaming video content described above with respect to system 100 (FIG. 1) and/or system 200 (FIG. 2).

Method 1600 can comprise activity 1603 of configuring the application module to control the user computer device based on an eye gesture of the user of the application module captured in streaming video content. The eye gesture can be similar or identical to one of the eye gestures described above with respect to system 100 (FIG. 1) and/or system 200 (FIG. 2). In some embodiments, activity 1602 and/or activity 1603 can be omitted. As an example, performing one or more of activities 1601-1603 can include writing computer source code and/or copying computer source code and/or object code.

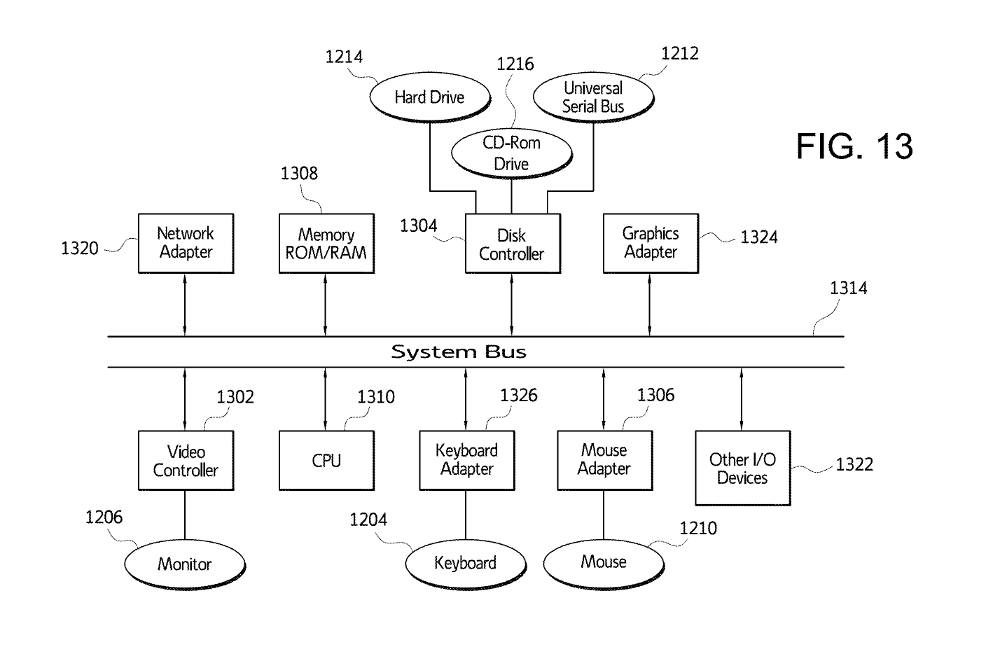

Turning back in the drawings, FIG. 12 illustrates an exemplary embodiment of computer system 1200 that can be suitable for implementing an embodiment of user computer device 104 (FIG. 1), centralized computer device 105 (FIG. 1), user computer device 204 (FIG. 2), centralized computer device 205 (FIG. 2) and/or another part of system 100 (FIG. 1) and/or system 200 (FIG. 2), as well as part or all of method 300 (FIG. 3), method 600 (FIG. 6), and/or method 800 (FIG. 8). Computer system 1200 includes chassis 1202 containing one or more circuit boards (not shown), Universal Serial Bus (USB) 1212, Compact Disc Read-Only Memory (CD-ROM) and/or Digital Video Disc (DVD) drive 1216, and hard drive 1214. A representative block diagram of the elements included on the circuit boards inside chassis 1202 is shown in FIG. 12. Central processing unit (CPU) 1310 in FIG. 13 is coupled to system bus 1314 in FIG. 13. In various embodiments, the architecture of CPU 1310 can be compliant with any of a variety of commercially distributed architecture families.

System bus 1314 in FIG. 13 also is coupled to memory 1308, where memory 1308 includes both non-volatile and/or non-transitory memory (e.g., read only memory (ROM)) and volatile and/or transitory memory (e.g., random access memory (RAM)). Non-volatile portions of memory 1308 or the ROM can be encoded with a boot code sequence suitable for restoring computer system 1200 (FIG. 12) to a functional state after a system reset. In addition, memory 1308 can include microcode such as a Basic Input-Output System (BIOS). In some examples, the one or more memory storage modules of the various embodiments disclosed herein can include memory 1308, USB 1212 (FIGS. 12-13), hard drive 1214 (FIGS. 12-13), and/or CD-ROM or DVD drive 1216 (FIGS. 12-13). In the same or different examples, the one or more memory storage modules of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Examples of common operating systems can include Microsoft® Windows, Mac® operating system (OS), UNIX® OS, and Linux® OS. Common operating systems for a mobile electronic device include the iPhone® operating system by Apple Inc. of Cupertino, Calif., United States of America, the Blackberry® operating system by Research In Motion (RIM) of Waterloo, Ontario, Canada, the Palm® operating system by Palm, Inc. of Sunnyvale, Calif., United States, the Android operating system developed by the Open Handset Alliance, the Windows Mobile operating system by Microsoft Corp. of Redmond, Wash., United States of America, or the Symbian operating system by Nokia Corp. of Keilaniemi, Espoo, Finland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

In the depicted embodiment of FIG. 13, various I/O devices such as disk controller 1304, graphics adapter 1324, video controller 1302, keyboard adapter 1326, mouse adapter 1306, network adapter 1320, and other I/O devices 1322 can be coupled to system bus 1314. Keyboard adapter 1326 and mouse adapter 1306 are coupled to keyboard 1204 (FIGS. 12-13) and mouse 1210 (FIGS. 12-13), respectively, of computer system 1200 (FIG. 12). While graphics adapter 1324 and video controller 1302 are indicated as distinct units in FIG. 13, video controller 1302 can be integrated into graphics adapter 1324, or vice versa in other embodiments. Video controller 1302 is suitable for refreshing monitor 1206 (FIGS. 12-13) to display images on a screen 1208 (FIG. 12) of computer system 1200 (FIG. 12). Disk controller 1304 can control hard drive 1214 (FIGS. 12-13), USB 1212 (FIGS. 12-13), and CD-ROM drive 1216 (FIGS. 12-13). In other embodiments, distinct units can be used to control each of these devices separately.

In some embodiments, network adapter 1320 can be part of a WNIC (wireless network interface controller) card (not shown) plugged or coupled to an expansion port (not shown) in computer system 1200. In other embodiments, the WNIC card can be a wireless network card built into computer system 1200. A wireless network adapter can be built into computer system 1200 by having wireless Ethernet capabilities integrated into the motherboard chipset (not shown), or implemented via a dedicated wireless Ethernet chip (not shown), connected through the PCI (peripheral component interconnector) or a PCI express bus. In other embodiments, network adapter 1320 can be a wired network adapter.

Although many other components of computer system 1200 (FIG. 12) are not shown, such components and their interconnection are well known to those of ordinary skill in the art. Accordingly, further details concerning the construction and composition of computer system 1200 and the circuit boards inside chassis 1202 (FIG. 12) are not discussed herein.

When computer system 1200 in FIG. 12 is running, program instructions stored on a USB-equipped electronic device connected to USB 1212, on a CD-ROM or DVD in CD-ROM and/or DVD drive 1216, on hard drive 1214, or in memory 1308 (FIG. 13) are executed by CPU 1310 (FIG. 13). A portion of the program instructions, stored on these devices, can be suitable for carrying out at least part of system 100 (FIG. 1), system 200 (FIG. 2), method 300 (FIG. 3), method 600 (FIG. 4), and/or method 800 (FIG. 8).

Although computer system 1200 is illustrated as a desktop computer in FIG. 12, there can be examples where computer system 1200 can take a different form factor (e.g., a mobile electronic device) while still having functional elements similar to those described for computer system 1200. In some embodiments, computer system 1200 can comprise a single computer, a single server, or a cluster or collection of computers or servers, or a cloud of computers or servers. Typically, a cluster or collection of servers can be used when the demand on computer system 1200 exceeds the reasonable capability of a single server or computer. These embodiments can be suitable for implementing centralized computer device 105 (FIG. 1), centralized computer device 205 (FIG. 2), and/or the centralized computer devices described above with respect to method 300 (FIG. 3), method 600 (FIG. 6) and/or method 800 (FIG. 8).

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the activities of methods 300 (FIG. 3), method 600 (FIG. 6), and/or method 800 (FIG. 8) may be comprised of many other activities and/or can be performed by many different modules, in many other orders, that any element of FIGS. 1-16 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
an engagement module, the engagement module being at least partially operable on one or more centralized processing modules of a centralized computer device and at least partially storable at one or more non-transitory centralized memory storage modules of the centralized computer device;
wherein:
the engagement module is configured to communicate with an application module, the application module being at least partially operable on one or more user processing modules of a user computer device and at least partially storable in one or more non-transitory user memory storage modules of the user computer device;
the user computer device comprises a user interface;
the engagement module is configured to communicate with the application module to solicit via the application module a user to create video content;
the application module comprises:
a user interface module configured to communicate with the user interface to permit the user to communicate with and operate the application module;
the centralized computer device is located remotely from the user computer device; and
the centralized computer device is configured to communicate with the user computer device.

2. The system of claim 1 wherein:
the engagement module is configured to offer one or more incentives to the user in order to solicit the user to create the video content;
the engagement module is configured to solicit via the application module the user to perform one or more user actions regarding the video content;
the one or more user actions comprises at least one of:
identifying one or more locations of the video content;
identifying one or more times of the video content;
identifying one or more dates of the video content;
identifying one or more participants of the video content;
commenting on a substantive content of the video content;
endorsing the video content;
sharing the video content; or
locating similar video content;
the engagement module is further configured to offer the one or more incentives to the user in order to solicit the user to perform the one or more user actions regarding the video content;
and
the one or more incentives comprise at least one of:
an offering of at least one intrinsic award to the user; or
an offering of at least one extrinsic award to the user.

3. The system of claim 1 wherein:
the system comprises the centralized computer device;
the centralized computer device comprises an input device and a display device; and
the input device and the display device are configured to permit an operator of the centralized computer device to manage the centralized computer device.

4. The system of claim 1 wherein:
the user computer device comprises a mobile electronic device; and
the application module comprises a mobile electronic device software application.

5. The system of claim 1 wherein:
the user computer device comprises a wearable user computer device; and
the application module comprises a wearable user computer device software application.

6. The system of claim 1 wherein:
the video content comprises at least one of recorded video content or streaming video content.

7. A method of manufacturing a system, the method comprising:
manufacturing an engagement module, the engagement module being at least partially operable on one or more centralized processing modules of a centralized computer device and at least partially storable at one or more non-transitory centralized memory storage modules of the centralized computer device, the centralized computer device being located remotely from the user computer device and being configured to communicate with a user computer device comprising a user interface, wherein manufacturing the engagement module comprises:
configuring the engagement module to communicate with an application module, the application module (i) being at least partially operable on one or more user processing modules of the user computer device and at least partially storable in one or more non-transitory user memory storage modules of the user computer device, and (ii) comprising a user interface module configured to communicate with the user interface to permit a user to communicate with and operate the application module; and
configuring the engagement module to solicit via the application module the user to create video content.

8. The method of claim 7 further comprising:
configuring the engagement module to offer one or more incentives to the user in order to solicit the user to create the video content;
configuring the engagement module to solicit via the application module the user to perform one or more user actions regarding the video content, the one or more user actions comprising at least one of: (a) identifying one or more locations of the video content; (b) identifying one or more times of the video content; (c) identifying one or more dates of the video content; (d) identifying one or more participants of the video content; (e) endorsing the video content; (f) sharing the video content; or (g) locating similar video content; and
configuring the engagement module to further offer the one or more incentives to the user in order to solicit via the application module the user to perform the one or more user actions regarding the video content;
wherein the one or more incentives comprise at least one of:
an offering of at least one intrinsic award to the user; or
an offering of at least one extrinsic award to the user.

9. The method of claim 7 wherein at least one of:
the user computer device comprises a mobile electronic device, and the application module comprises a mobile electronic device software application; or
the user computer device comprises a wearable user computer device, and the application module comprises a wearable user computer device software application.

10. A method, at least part of the method being implemented via execution of computer instructions configured to run at one or more user processing modules of a user computer device and configured to be stored in one or more non-transitory user memory storage modules of the user computer device, the user computer device comprising a user interface, and the method comprising:
executing one or more first computer instructions configured to solicit a user to create video content; and
executing one or more second computer instructions configured to receive the video content from the user;
wherein:
the computer instructions comprise the one or more first computer instructions and the one or more second computer instructions.

11. The method of claim 10 wherein at least one of:
the user computer device comprises a mobile electronic device; or
the user computer device comprises a wearable user computer device.

12. The method of claim 11 wherein at least one of:
executing the one or more first computer instructions comprises executing one or more third computer instructions configured to solicit the user to create the video content via a user interface of the user computer device; or
executing the one or more second computer instructions comprises executing one or more fourth computer instructions configured to receive the video content from the user via the user computer device, where the user created the video content using the user computer device.

13. The method of claim 10 wherein:
executing the one or more first computer instructions comprises executing one or more third computer instructions configured to offer one or more first incentives to the user in order to solicit the user to create the video content.

14. The method of claim 13 wherein:
executing the one or more third computer instructions comprises at least one of:
executing one or more fourth computer instructions configured to offer at least one intrinsic award to the user; or
executing one or more fifth computer instructions configured to offer at least one extrinsic award to the user;
and
the one or more first incentives comprise at least one of the at least one intrinsic award or the at least one extrinsic award.

15. The method of claim 14 further comprising:
providing the at least one of the at least one intrinsic award or the at least one extrinsic award to the user.

16. The method of claim 10 further comprising:
after executing the one or more first computer instructions, executing one or more third computer instructions configured to solicit the user to perform one or more user actions regarding the video content;
wherein:
the computer instructions comprise the one or more third computer instructions.

17. The method of claim 16 wherein:
executing the one or more third computer instructions comprises at least one of:
executing one or more fourth computer instructions configured to solicit the user to identify one or more locations of the video content;
executing one or more fifth computer instructions configured to solicit the user to identify one or more times of the video content;
executing one or more sixth computer instructions configured to solicit the user to identify one or more dates of the video content;
executing one or more seventh computer instructions configured to solicit the user to identify one or more participants of the video content;
executing one or more eighth computer instructions configured to solicit the user to comment on a substantive content of the video content;
executing one or more ninth computer instructions configured to solicit the user to endorse the video content;
executing one or more tenth computer instructions configured to solicit the user to share the video content; or
executing one or more eleventh computer instructions configured to solicit the user to locate similar video content.

18. The method of claim 16 wherein at least one of:
executing the one or more third computer instructions comprises executing one or more fourth computer instructions configured to solicit the user to perform two or more of the one or more user actions regarding the video content according to one of a predetermined order or an optimized order; or
executing the one or more third computer instructions comprises executing one or more fifth computer instructions configured to offer one or more second incentives to the user in order to solicit the user to perform the one or more user actions regarding the video content.

19. The method of claim 10 further comprising at least one of:
executing one or more third computer instructions configured to facilitate creation of the video content at the user computer device;
executing one or more fourth computer instructions configured to facilitate editing of the video content at the user computer device;
executing the one or more fifth computer instructions configured to identify a first target of interest in the video content, and after executing the one or more fifth computer instructions, executing one or more sixth computer instructions configured to provide media content relating to the video content;
executing one or more seventh computer instructions configured to receive a user privacy setting;
broadcasting social content to at least one other user computer device;
receiving the social content from the at least one other user computer device.
wherein:
the computer instructions comprise the at least one of the one or more third computer instructions when the one or more third computer instructions are executed, the one or more fourth computer instructions when the one or more fourth computer instructions are executed, the one or more fifth computer instructions and the one or more sixth computer instructions when the one or more fifth computer instructions and when the one or more sixth computer instructions are executed, or the one or more seventh computer instructions when the one or more seventh computer instructions are executed.

20. The method of claim 10 wherein at least one of:
executing the one or more first computer instructions comprises executing one or more third computer instructions configured to solicit the user to create the video content within a predetermined distance of a location of a first target of interest;
executing the one or more first computer instructions comprises executing one or more fourth computer instructions configured to solicit the user to create the video content as point-of-view video content;
executing the one or more first computer instructions comprises executing one or more fifth computer instructions configured to solicit the user to create the video content such that the video content comprises a second target of interest; or
executing the one or more first computer instructions comprises executing one or more sixth computer instructions configured to solicit the user to create the video content in response to identifying a third target of interest.
